(19) United States
(12) Patent Application Publication
(10) Pub. No.: US 2011/0019170 A1
(43) Pub. Date: Jan. 27, 2011

(54) PROJECTION EXPOSURE APPARATUS AND STAGE UNIT, AND EXPOSURE METHOD

(75) Inventors: Yasunaga Kayama, Tokyo (JP); Dai Arai, Tokyo (JP)

Correspondence Address: OLIFF & BERRIDGE, PLC, P.O. BOX 320850, ALEXANDRIA, VA, 22320-4850, US

(73) Assignee: NIKON CORPORATION, Tokyo (JP)

(21) Appl. No.: 12/896,580

(22) Filed: Oct. 1, 2010

Related U.S. Application Data
(63) Continuation of application No. 11/603,986, filed on Nov. 24, 2006, now abandoned.
Application No. 11/603,986 is a division of application No. 10/582,488, filed on Jun. 12, 2006.

(30) Foreign Application Priority Data
Dec. 15, 2003 (JP) 2003-415893

(51) Int. Cl. G03B 27/52

(52) U.S. Cl. 355/30

(57) ABSTRACT

A projection exposure apparatus has a substrate table on which a substrate is mounted that can be moved holding the substrate, a position measuring system that measures positional information of the substrate table, and a correction unit that corrects positional deviation occurring in at least either the substrate or the substrate table due to supply of a liquid. In this case, the correction unit corrects the positional deviation occurring in at least either the substrate or the substrate table due to the supply of the liquid. Accordingly, exposure with high precision using a liquid immersion method is performed on the substrate.

This is a Continuation of application Ser. No. 11/603,986 filed Nov. 24, 2006, which is a Division of application Ser. No. 10/582,488 filed Jun. 12, 2006, which is a National Phase of PCT/JP2004/018604 filed Dec. 14, 2004. The disclosures of the prior applications are hereby incorporated by reference herein in their entirety.

### TECHNICAL FIELD

The present invention relates to projection exposure apparatus and stage units, and exposure methods, and more particularly to a projection exposure apparatus used in a lithography process when manufacturing electronic devices such as a semiconductor device, a liquid display device, or the like and a stage unit suitable for a sample stage of a precision instrument such as the projection exposure apparatus, and an exposure method performed by the exposure apparatus.

### BACKGROUND ART

In a lithography process for manufacturing electronic devices such as a semiconductor device (such as an integrated circuit), a liquid crystal display device and the like, a projection exposure apparatus is used that transfers an image of a pattern of a mask or a reticle (hereinafter generally referred to as a ‘reticle’) onto each shot area on a photosensitive substrate such as a wafer coated with a resist (photosensitive agent) or a glass plate and the like (hereinafter generally referred to as a ‘substrate’ or a ‘wafer’), via a projection optical system. Conventionally, the reduction projection exposure apparatus by the step-and-repeat method (the so-called stepper) has been frequently used as such a projection exposure apparatus; however, recently, the projection exposure apparatus by the step-and-scan method (the so-called scanning stepper (also called a scanner) that performs exposure by synchronously scanning the reticle and the wafer has also become relatively frequently used.

The resolution of the projection optical system installed in the projection exposure apparatus becomes higher when the wavelength of the exposure light used (exposure wavelength) becomes shorter, or when the numerical aperture (NA) of the projection optical system becomes larger. Therefore, as the integrated circuit becomes finer, the exposure wavelength used in the projection exposure apparatus is becoming shorter year by year, and the numerical aperture of the projection optical system is also increasing. The exposure wavelength currently mainstream is 248 nm of the KrF excimer laser, however, 193 nm of the ArF excimer laser, which is shorter than the KrF excimer laser, is also put to practical use.

Further, on performing exposure, the depth of focus (DOF) is also important as well as the resolution. Resolution R and depth of focus δ are respectively expressed in the following equations.

R=k₁·λ/NA (1)

δ=k₂·λ/NA² (2)

In this case, λ is the exposure wavelength, NA is the numerical aperture of the projection optical system, and k₁, k₂ are process factors. From equations (1) and (2), it can be seen that when exposure wavelength λ is shortened and numerical aperture NA is increased (a larger NA) for a higher resolution R, depth of focus δ becomes narrower. In the projection exposure apparatus, exposure is performed by making the surface of the wafer conform to the image plane of the projection optical system in the auto-focus method. Accordingly, depth of focus δ should preferably be wide to some extent. Therefore, proposals to substantially enlarge the depth of focus have been made in the past, such as the phase shift reticle method, the modified illumination method, and the multiplayer resist method.

As is described above, in the conventional projection exposure apparatus, depth of focus is becoming narrower due to shorter wavelength of the exposure light and larger numerical aperture of the projection optical system. And, in order to cope with higher integration of the integrated circuit, it is certain that the exposure wavelength will become much shorter in the future; however, in such a case, the depth of focus may become too narrow so that there may not be enough margin during the exposure operation.

Accordingly, a proposal on an immersion method has been made as a method for substantially shortening the exposure wavelength while enlarging (widening) the depth of focus more than the depth of focus in the air. In this immersion method, resolution is improved by making use of the fact that the wavelength of the exposure light in the liquid becomes 1/n of the wavelength in the air (n is the refractive index of the liquid which is normally around 1.2 to 1.6), and a space between the lower surface of the projection optical system and the surface of the wafer is filled with liquid such as water or an organic solvent. As well as improving the resolution, the immersion method also substantially enlarges the depth of focus n times when comparing it with the case when the same resolution is obtained without applying the immersion method to the projection optical system (supposing that such a projection optical system can be made). That is, the immersion method enlarges the depth of focus n times than in the atmosphere.

As one of the conventional arts utilizing the immersion method, ‘a projection exposure method and an apparatus in which when moving a substrate in a predetermined direction, a predetermined liquid is made to flow in the moving direction of the substrate so that the liquid fills the space between the front edge section of an optical element on the substrate side of the projection exposure apparatus and the surface of the substrate’ is known (e.g. refer to Patent Document 1 below).

According to the projection exposure method and the apparatus of Patent Document 1, exposure with both high resolution and with a greater depth of focus than in the air can be performed by the immersion method, and the liquid can also be filled stably in the space between the projection optical system and the substrate even when the projection optical system and the wafer are relatively moved, that is, the liquid can be held.

In the conventional art, however, because the liquid is supplied to the space between the front edge section of the optical element on the substrate side of the projection exposure apparatus and the surface of the substrate, that is, the liquid is supplied to a part of the substrate surface, in some cases the substrate or the substrate table on which the substrate is mounted was deformed due to the pressure (the main cause is surface tension and the weight of the water itself) of the liquid, or the distance between the projection optical system and the substrate fluctuated at times. Further, there were times when vibration was also generated in the substrate table, along with the liquid supply.

Such deformation of the substrate or the substrate table described above becomes error factors when measuring the position of the substrate on the substrate table using a laser interferometer. This is because the laser interferometer indirectly measures the position of the substrate on the premise that the positional relation between a reflection surface serving as a datum (e.g. a movable mirror reflection surface) and the substrate is constant, by measuring the position of the reflection surface.

Especially in the case of a scanning exposure apparatus, unlike a static exposure apparatus (a batch-exposure apparatus) such as the stepper, the change in the distance of the projection optical system and the substrate becomes the cause of positional errors of the substrate in the direction of the optical axis of the projection optical system, which is adjusted based on the output of a focus sensor fixed to the projection optical system. This was because in the case of a scanning exposure apparatus that performs exposure while moving the substrate stage, when positional errors of the substrate occur in the direction of the optical axis of the projection optical system, the probability was high that a control delay would occur in the focus control of the substrate, even if feedback control was performed on the position of the substrate in the optical axis direction via the substrate stage based on the output of the focus sensor.

Further, position deviation or the like that occurs with the liquid supply described above was not seen as a serious problem until now; however, because the overlay accuracy required in the projection exposure apparatus will likely be tighter than ever in the future due to the higher integration of the integrated circuit, it will become necessary to effectively keep the position deviation or the like that occurs with the liquid supply described above from degrading the position controllability of the substrate.

Patent Document 1: the Pamphlet of International Publication Number WO99/49504

### DISCLOSURE OF INVENTION

### Means for Solving the Problems

The present invention has been made in consideration of the circumstances described above, and according to the first aspect of the present invention, there is provided a projection exposure apparatus that supplies liquid in a space between a projection optical system and a substrate and transfers a pattern on the substrate via the projection optical system and the liquid, the apparatus comprising: a substrate table on which the substrate is mounted that can be moved holding the substrate; and a correction unit that corrects positional deviation occurring in at least one of the substrate and the substrate table due to supply of the liquid.

In this case, ‘positional deviation occurring in at least one of the substrate and the substrate table due to supply of the liquid,’ includes positional deviation occurring due to supply of the liquid in both the direction of the moving plane of the substrate table and the direction orthogonal to the moving plane.

According to this apparatus, the correction unit corrects the positional deviation occurring in at least one of the substrate and the substrate table due to supply of the liquid. Therefore, exposure with high precision in a situation similar to the one under exposure using a dry-type projection exposure apparatus, or more specifically, highly precise exposure that uses the immersion method with respect to the substrate under a situation where positional deviation occurring in at least one of the substrate and the substrate table due to supply of the liquid does not exist, can be achieved.

In this case, when the apparatus further comprises a position measuring system that measures positional information of the substrate table, the correction unit can correct positional deviation occurring in at least one of the substrate and the substrate table due to supply of the liquid according to the position of the substrate table.

In this case, the correction unit can correct an error in the positional information in at least one of the substrate and the substrate table measured directly or indirectly by the position measuring system, which occurs due to supply of the liquid.

In the projection exposure apparatus of the present invention, the correction unit can correct positional deviation that occurs by a change in the shape of the substrate table.

In the projection exposure apparatus of the present invention, the substrate table has a fiducial member used for position setting, and the correction unit can correct positional deviation between the fiducial member and the substrate.

In the projection exposure apparatus of the present invention, the correction unit can correct the distance between the projection optical system and the substrate in an optical axis direction of the projection optical system.

In the projection exposure apparatus of the present invention, the correction unit can correct the positional deviation according to a physical quantity related to the liquid. In this case, the physical quantity related to the liquid can include at least one of pressure of the liquid and surface tension of the liquid.

In the projection exposure apparatus of the present invention, the correction unit can correct positional deviation that occurs by vibration of the substrate table.

In the projection exposure apparatus of the present invention, the apparatus can further comprise: a mask stage on which a mask having the pattern formed is mounted that can be moved holding the mask; and the correction unit can correct the positional deviation by changing a thrust given to at least one of the substrate table and the mask stage. In this case, the correction unit can comprise a controller that changes the thrust by feedforward control.

In the projection exposure apparatus of the present invention, the correction unit can correct the positional deviation based on position measuring results of a transferred image of the pattern transferred on the substrate, or the correction unit can correct the positional deviation based on simulation results.

According to the second aspect of the present invention, there is provided a stage unit that has a substrate table which movably holds a substrate whose surface is supplied with liquid, the unit comprising: a position measuring unit that measures positional information of the substrate table; and a correction unit that corrects positional deviation occurring in at least one of the substrate and the substrate table due to supply of the liquid.

According to this unit, the correction unit corrects the positional deviation occurring in at least one of the substrate and the substrate table due to supply of the liquid. Therefore, the substrate and the substrate table can be moved based on the measurement results without being affected by the liquid supplied to the surface of the substrate.

In the projection exposure apparatus of the present invention, the correction unit can correct positional deviation that occurs by a change in the shape of the substrate table.

In the projection exposure apparatus of the present invention, the substrate table has a fiducial member used for position setting, and the correction unit can correct positional deviation between the fiducial member and the substrate.

According to the third aspect of the present invention, there is provided an exposure method in which liquid is supplied to a space between a projection optical system and a substrate held on a substrate table and a pattern is transferred onto the substrate via the projection optical system and the liquid, the method comprising: a detection process in which a change occurring in at least one of the substrate and the substrate table due to supply of the liquid is detected; and a transfer process in which the pattern is transferred onto the substrate based on results of the detection.

### BRIEF DESCRIPTION OF THE DRAWINGS

FIG. 1 is a view schematically showing a configuration of a projection exposure apparatus in an embodiment;

FIG. 2 is a perspective view of a wafer table in FIG. 1;

FIG. 3 is a sectional view of a liquid supply/drainage unit, along with the lower end section of a barrel and a piping system;

FIG. 4 is a sectional view of a line B-B in FIG. 3;

FIG. 5 is a view showing a state where liquid is supplied to the liquid supply/drainage unit;

FIG. 6 is a view for describing a focal point position detection system;

FIG. 7 is a block diagram showing a partially omitted configuration of a control system of the projection exposure apparatus in the embodiment; and

FIG. 8 is a block diagram showing a wafer stage control system installed inside the stage controller.

### BEST MODE FOR CARRYING OUT THE INVENTION

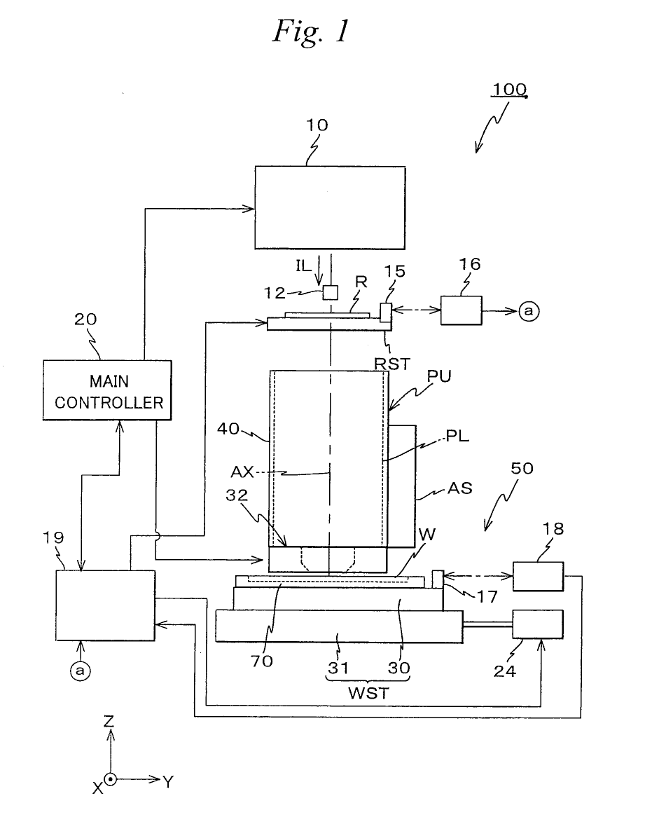

An embodiment of the present invention will be described below, referring to FIGS. 1 to 8.

FIG. 1 shows an entire configuration of a projection exposure apparatus 100 related to the embodiment of the present invention. Projection exposure apparatus 100 is a projection exposure apparatus (the so-called scanning stepper) by the step-and-scan method. Projection exposure apparatus 100 is equipped with an illumination system 10, a reticle stage RST that holds a reticle R serving as a mask, a projection unit PU, a stage unit 50 that has a wafer table 30 serving as a substrate table on which a wafer W serving as a substrate is mounted, a control system for such parts and the like.

As is disclosed in, for example, Kokai (Japanese Unexamined Patent Application Publication) No. 2001-313250 and its corresponding U.S. Patent Application Publication No. 2003/0025890 description or the like, illumination system 10 is configured including a light source, an illuminance uniformity optical system that contains an optical integrator or the like, a beam splitter, a relay lens, a variable ND filter, a reticle blind (none of which are shown). In illumination system 10, an illumination light (exposure light) IL illuminates a slit-shaped illumination area set by the reticle blind on reticle R where the circuit pattern or the like is fabricated with substantially uniform illuminance. As illumination light IL, the ArF excimer laser beam (wavelength: 193 nm) is used as an example. As illumination light IL, far ultraviolet light such as the KrF excimer laser beam (wavelength: 248 nm) or bright lines in the ultraviolet region generated by an ultra high-pressure mercury lamp (such as the g-line or the i-line) can also be used. Further, as the optical integrator, parts such as a fly-eye lens, a rod integrator (an internal reflection type integrator), or a diffraction optical element can be used. As illumination system 10, besides the system described above, a system having the arrangement disclosed in, for example, Japanese Patent Application Laid-open No. H06-349701 and its corresponding U.S. Pat. No. 5,534,970, can also be employed. As long as the national laws in designated states or elected states, to which this international application is applied, permit, the above disclosures of each of the publications and the corresponding U.S. Patent application publication and U.S. Patent cited above are fully incorporated herein by reference.

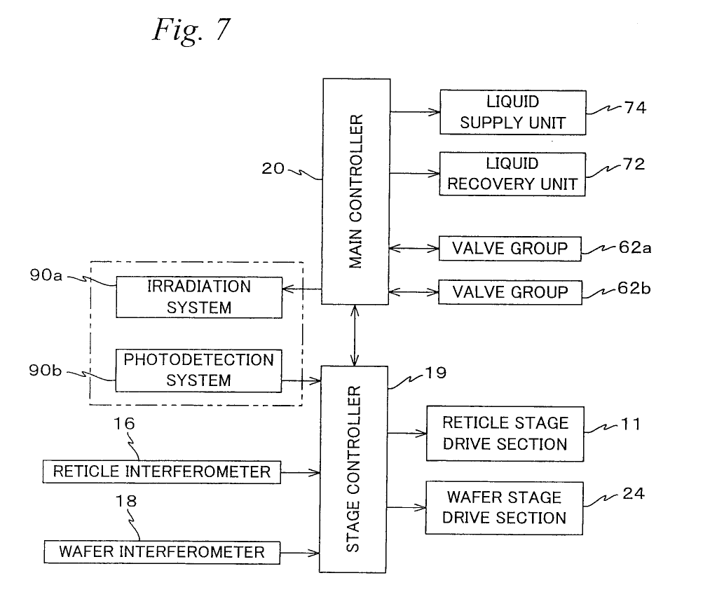

On reticle stage RST, reticle R is fixed, for example, by vacuum suction. Reticle stage RST is structured finely drivable in an XY plane perpendicular to the optical axis of illumination system 10 (coinciding with an optical axis AX of a projection optical system PL, which will be described later) by a reticle stage drive section 11 (not shown in FIG. 1, refer to FIG. 7) that comprises parts such as a linear motor. It is structured also drivable in a predetermined scanning direction (in this case, a Y-axis direction, which is the lateral direction of the page surface in FIG. 1) at a designated scanning speed.

The position of reticle stage RST within the reticle stage movement plane is constantly detected by a reticle laser interferometer (hereinafter referred to as ‘reticle interferometer’) 16 via a movable mirror 15 at a resolution, for example, around 0.5 to 1 nm. In actual, on reticle stage RST, a movable mirror that has a reflection surface orthogonal to the Y-axis direction and a movable mirror that has a reflection surface orthogonal to an X-axis direction are arranged, and corresponding to these movable mirrors, a reticle Y interferometer and a reticle X interferometer are arranged; however in FIG. 1, such details are representatively shown as movable mirror 15 and reticle interferometer 16. Incidentally, for example, the edge surface of reticle stage RST may be polished in order to form a reflection surface (corresponds to the reflection surface of movable mirror 15). Further, at least one corner cubic mirror (such as a retroreflector) may be used instead of the reflection surface that extends in the X-axis direction used for detecting the position of reticle stage RST in the scanning direction (the Y-axis direction in the embodiment). Of the interferometers reticle Y interferometer and reticle X interferometer, one of them, such as reticle Y interferometer, is a dual-axis interferometer that has two measurement axes, and based on the measurement values of reticle Y interferometer, the rotation of reticle stage RST in a θz direction (the rotational direction around a Z-axis) can be measured in addition to the Y position of reticle stage RST.

The measurement values of reticle interferometer 16 are sent to a stage controller 19, and stage controller 19 computes the position of reticle stage RST in the X, Y, and θz directions based on the measurement values of reticle interferometer 16, and then supplies the computed positional information to a main controller 20. Stage controller 19 drives and controls reticle stage RST via reticle stage drive section 11 based on the position of reticle stage RST, according to the instructions from main controller 20.

Above reticle R, a reticle alignment detection system 12 is disposed in pairs in the X-axis direction at a predetermined distance (however, reticle alignment detection system 12 in the depth of the page surface is not shown in FIG. 1). Although it is omitted in the drawings, each reticle alignment detection system 12 is configured including an epi-illumination system for illuminating a mark subject to detection with an illumination light that has the same wavelength as illumination light IL and a detection system for picking up the image of the mark subject to detection. The detection system comprises an image-forming optical system and an imaging device, and the detection results of the detection system (i.e. the detection results of the mark by reticle alignment detection system 12) are supplied to main controller 20. In this case, a mirror (not shown; an epi-illumination mirror) for directing the illumination light emitted from the epi-illumination system onto reticle R and also for directing the detection light generated from reticle R by the illumination to the detection system of reticle alignment detection system 12 is disposed freely withdrawable on the optical path of illumination light IL. And when the exposure frequency begins, the epi-illumination mirror is withdrawn outside the optical path of illumination light IL by a drive unit (not shown) based on the instructions from main controller 20, before the irradiation of illumination light IL in order to transfer the pattern of reticle R onto wafer W.

Projection unit PU is disposed below reticle stage RST, as in FIG. 1. Projection unit PU comprises a barrel 40, and projection optical system PL, which is made up of a plurality of optical elements, or to be more specific, a plurality of lenses (lens elements) that share the same optical axis AX in the Z-axis direction, held at a predetermined positional relationship within the barrel. As projection optical system PL, for example, a both-side telecentric dioptric system that has a predetermined projection magnification (such as ¼ or ⅕ times) is used. Therefore, when illumination light IL from illumination system 10 illuminates the illumination area on reticle R, illumination light IL that has passed through reticle R forms a reduced image of the circuit pattern within the illumination area on reticle R (a partial reduced image of the circuit pattern) on wafer W whose surface is coated with a resist (photosensitive agent), via projection unit PU (projection optical system PL).

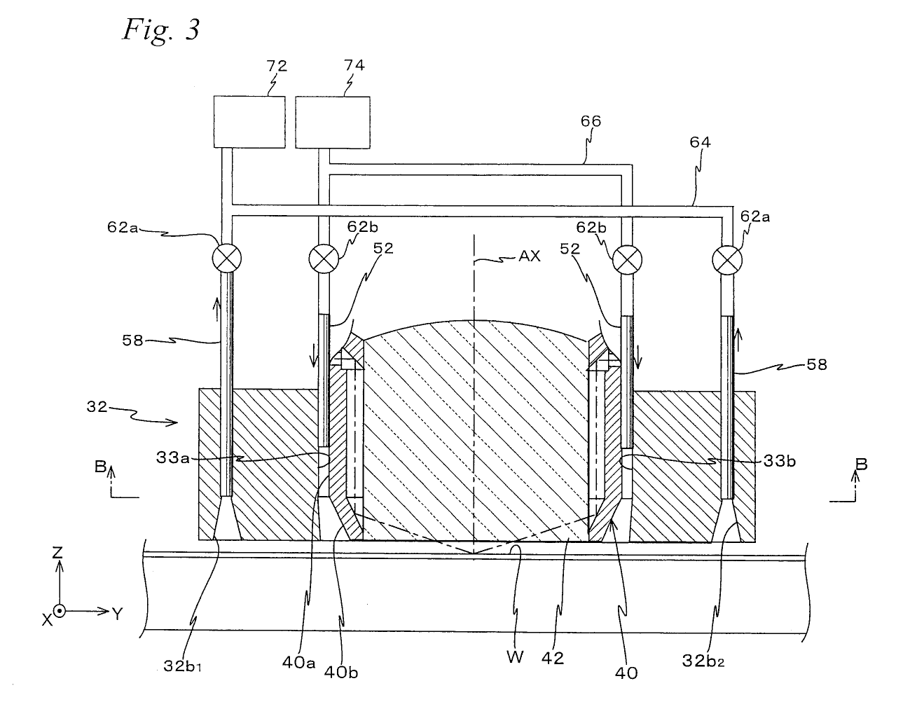

Further, because exposure apparatus 100 of the embodiment performs exposure using the immersion method (to be described later), in the vicinity of a lens 42 (refer to FIG. 3) serving as an optical element that constitutes projection optical system PL located closest to the image plane (wafer W), a liquid supply/drainage unit 32 is attached so that it surrounds the tip of barrel 40, which holds lens 42. Details on liquid supply/drainage unit 32 and the arrangement of the piping system connected to the unit and the like will be described, later in the description.

On the side surface of projection unit PU, an off-axis alignment system (hereinafter shortly referred to as an ‘alignment system’) AS is disposed. As alignment system AS, for example, a sensor of an FIA (Field Image Alignment) system based on an image-processing method is used. This sensor irradiates a broadband detection beam that does not expose the resist on the wafer on a target mark, picks up the images of the target mark formed on the photodetection surface by the reflection light from the target mark and an index (not shown; an index pattern on an index plate arranged inside alignment system AS) with a pick-up device (such as a CCD), and outputs the imaging signals. Incidentally, the sensor used as alignment sensor AS is not limited to the FIA system sensor, and it is a matter of course that an alignment sensor that irradiates a coherent detection light on a target mark and detects the scattered light or diffracted light generated from the target mark, or a sensor that detects two diffracted lights (e.g. diffracted lights of the same order, or diffracted lights diffracting in the same direction) generated from the target mark by making them interfere with each other can be used independently, or appropriately combined. The imaging results of alignment system AS is output to main controller 20.

Stage unit 50 comprises parts such as a wafer stage WST, a wafer holder 70 arranged on wafer stage WST, and a wafer stage drive section 24 which drives wafer stage WST. As is shown in FIG. 1, wafer stage WST is disposed below projection optical system PL on a base (not shown). Wafer stage WST comprises an XY stage 31, which is driven in the XY direction by linear motors or the like (not shown) constituting wafer stage drive section 24, and wafer table 30, which is mounted on XY stage 31 and is finely driven in the Z-axis direction, a gradient direction with respect to the XY plane (the rotational direction around the X-axis (θx direction), and the rotational direction around the Y-axis (θy direction)) by a Z tilt drive mechanism (not shown) that also constitutes wafer stage drive section 24. And, wafer holder 70 is mounted on wafer table 30, and with wafer holder 70, wafer W is fixed by vacuum chucking or the like.

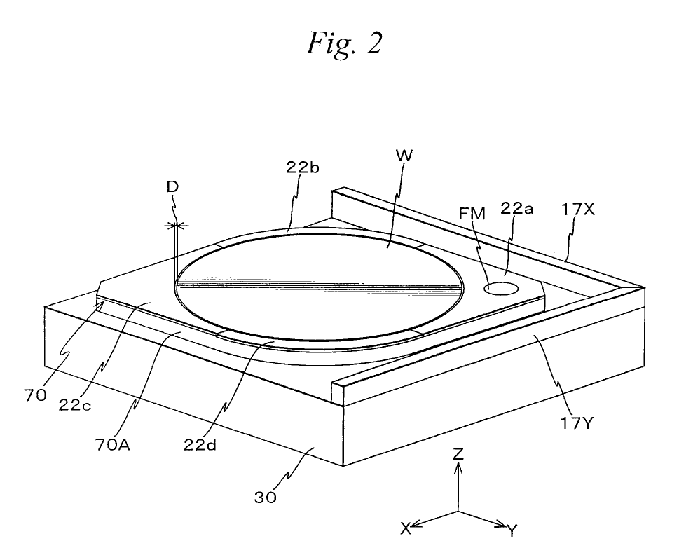

As is shown in the perspective view in FIG. 2, in the peripheral portion of the area where wafer W is mounted (the circular area in the center), wafer holder 70 comprises a main body section 70A that has a specific shape where two corners located on one of the diagonal lines of a square-shaped wafer table 30 are projecting and the remaining two corners located on the remaining diagonal line are shaped in quarter arcs of a circle one size larger that the circular area described above, and four auxiliary plates 22a to 22d arranged in the periphery of the area where wafer W is to be mounted so that they substantially match the shape of main body section 70A. The surface of such auxiliary plates 22a to 22d are arranged so that they are substantially the same height as the surface of wafer W (the height difference between the auxiliary plates and the wafer should be up to around 1 mm).

As is shown in FIG. 2, a gap D is formed between auxiliary plates 22a to 22d and wafer W, respectively, and the size of gap D is set at around 3 mm or under. Further, wafer W also has a notch (a V-shaped notch). However, since the size of the notch is around 1 mm, which is smaller than gap D, it is omitted in the drawings.

Further, in auxiliary plate 22a, a circular opening is formed in a part of the plate, and a fiducial mark plate FM is tightly embedded in the opening. Fiducial mark plate FM is arranged so that its surface is co-planar with auxiliary plate 22a. On the surface of fiducial mark plate FM, at least a pair of reticle alignment fiducial marks, a fiducial mark for baseline measurement of alignment system AS (none of which are shown) and the like are formed. That is, fiducial mark plate FM also functions as the fiducial member when deciding the position of wafer table 30.

Referring back to FIG. 1, XY stage 31 is structured movable not only in the scanning direction (the Y-axis direction) but also in a non-scanning direction (the X-axis direction) perpendicular to the scanning direction so that the shot areas serving as a plurality of divided areas on wafer W can be positioned at an exposure area conjugate with the illumination area. And, XY stage 31 performs a step-and-scan operation in which an operation for scanning exposure of each shot area on wafer W and an operation (movement operation performed between divided areas) for moving wafer W to the acceleration starting position (scanning starting position) to expose the next shot are repeated.

The position of wafer stage WST within the XY plane (including rotation around the Z-axis (the θz rotation)) is detected at all times by a wafer laser interferometer (hereinafter referred to as ‘wafer interferometer’) 18 via a movable mirror 17 arranged on the upper surface of wafer table 30, at a resolution, for example, around 0.5 to 1 nm. As is previously described, on wafer table 30, wafer W is suctioned and fixed via wafer holder 70. Accordingly, the positional relation between movable mirror 17 and wafer W is maintained at a constant relation unless deformation occurs in wafer table 30, therefore, measuring the position of wafer table 30 via movable mirror 17 means that the position of wafer W is measured indirectly via movable mirror 17. That is, the reflection surface of movable mirror 17 also serves as a datum for measuring the position of wafer W, and movable mirror 17 is a fiducial member for measuring the position of wafer W.

In actual, on wafer table 30, for example, as is shown in FIG. 2, a Y movable mirror 17Y that has a reflection surface orthogonal to the scanning direction (the Y-axis direction) and an X movable mirror 17X that has a reflection surface orthogonal to the non-scanning direction (the X-axis direction) are arranged, and corresponding to the movable mirrors, as the wafer interferometers, an X interferometer that irradiates an interferometer beam perpendicularly on X movable mirror 17X and a Y interferometer that irradiates an interferometer beam perpendicularly on Y movable mirror 17Y are arranged; however, such details are representatively shown as movable mirror 17 and wafer interferometer 18 in FIG. 1. Incidentally, the X interferometer and the Y interferometer of wafer interferometer 18 are both multi-axis interferometers that have a plurality of measurement axes, and with these interferometers, other than the X and Y positions of wafer stage WST (or to be more precise, wafer table 30) and yawing (the θz rotation, which is rotation around the Z-axis), pitching (the θx rotation, which is rotation around the X-axis) and rolling (the θy rotation, which is rotation around the Y-axis) can also be measured. And, for example, the edge surface of wafer table 30 may be polished in order to form a reflection surface (corresponds to the reflection surface of movable mirrors 17X and 17Y). Further, the multi-axis interferometers may detect relative positional information in the optical axis direction (the Z-axis direction) of projection optical system PL, by irradiating a laser beam on a reflection surface arranged on the frame on which projection optical system PL is mounted (not shown), via a reflection surface arranged on wafer table 30 at an inclination of 45 degrees.

The measurement values of wafer interferometer 18 are sent to stage controller 19. Based on the measurement values of wafer interferometer 18, stage controller 19 computes the X, Y positions and the θz rotation of wafer table 30. Further, in the case the θx rotation and the θy rotation can also be computed based on the output of wafer interferometer 18, stage controller 19 computes the X, Y positions of wafer table 30 whose positional errors within the XY plane of wafer table 30 caused by the θx rotation and the θy rotation have been corrected. Then, the information on the X, Y positions and the θz rotation of wafer table 30 computed by stage controller 19 is supplied to main controller 20. And, according to instructions from main controller 20, stage controller 19 controls the wafer table via wafer stage drive section 24, based on the positional information of wafer table 30 described above.

Inside stage controller 19 of the embodiment, a wafer stage control system (to be described later) and a reticle stage control system (not shown) are installed.

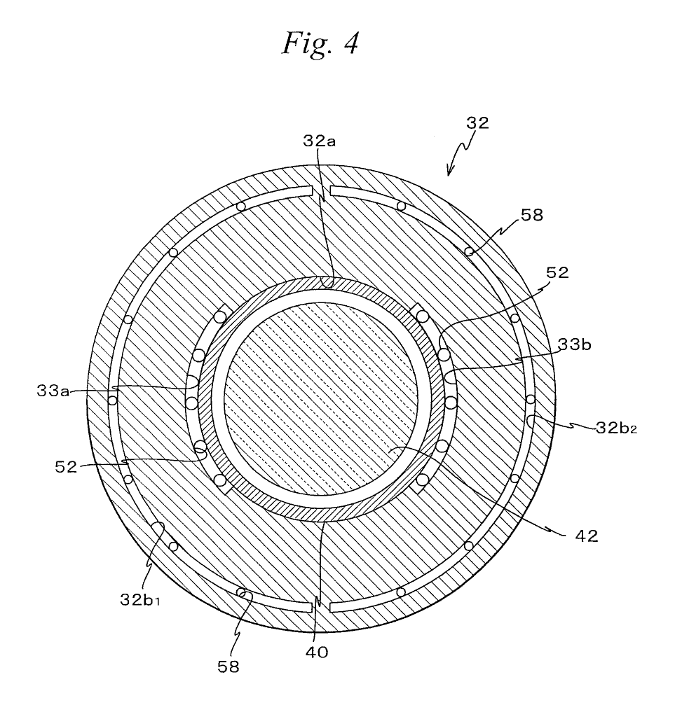

Next, details on liquid supply/drainage unit 32 will be described, referring to FIGS. 3 and 4. FIG. 3 shows a sectional view of liquid supply/drainage unit 32, along with the lower end section of barrel 40 and the piping system. Further, FIG. 4 shows a sectional view of line B-B in FIG. 3.

As is shown in FIG. 3, on the end of the image plane side of barrel 40 of projection unit PU (the lower end section), a small diameter section 40a is formed whose diameter is smaller than other sections, and the tip of small diameter section 40a is shown as a tapered section 40b whose diameter becomes smaller the lower it becomes. In this case, lens 42, which is closest to the image plane among the lenses constituting projection optical system PL, is held within small diameter section 40a. The lower surface of lens 42 should be parallel to the XY plane orthogonal to optical axis AX.

Liquid supply/drainage unit 32 has a cylindrical shape when viewed from the front (and the side), and in the center, an opening 32a that has a circular section into which small diameter section 40a of barrel 40 can be inserted downward (the −Z direction) from above (the +Z direction) is formed in a vertical direction, as is shown in FIG. 4. Opening 32a is an opening that has a rough circular shape as a whole (refer to FIG. 4), having arc-shaped sections 33a and 33b whose diameter is larger than the diameter of opening 32a arranged partially on both sides in the X-axis direction. As is shown in FIG. 3, the inner wall surface of arc-shaped sections 33a and 33b has a substantially constant diameter from the upper end to the vicinity of the lower end, and in the section lower than the vicinity of the lower end, the end is tapered and the diameter becomes smaller. As a consequence, between each of the inner wall surfaces of arc-shaped sections 33a and 33b of opening 32a of liquid supply/drainage unit 32 and the outer surface of tapered section 40b of small diameter section 40a of barrel 40, liquid supply nozzles are respectively formed that widens slightly when viewed from above (narrows slightly when viewed from below). In the following description, these liquid supply nozzles will be appropriately described as ‘liquid supply nozzle 33a and liquid supply nozzle 33b,’ using the same reference numerals as arc-shaped sections 33a and 33b.

As is obvious from FIGS. 3 and 4, between each of the inner surfaces of arc-shaped sections 33a and 33b and small diameter section 40a of barrel 40, spaces are formed that are arc-shaped in a planar view (when viewed from above or below). In such spaces, at a substantially equal interval, one end of a plurality of supply pipes 52 is inserted in the vertical direction, and the opening on one end of each of the supply pipes 52 faces liquid supply nozzle 33a or liquid supply nozzle 33b.

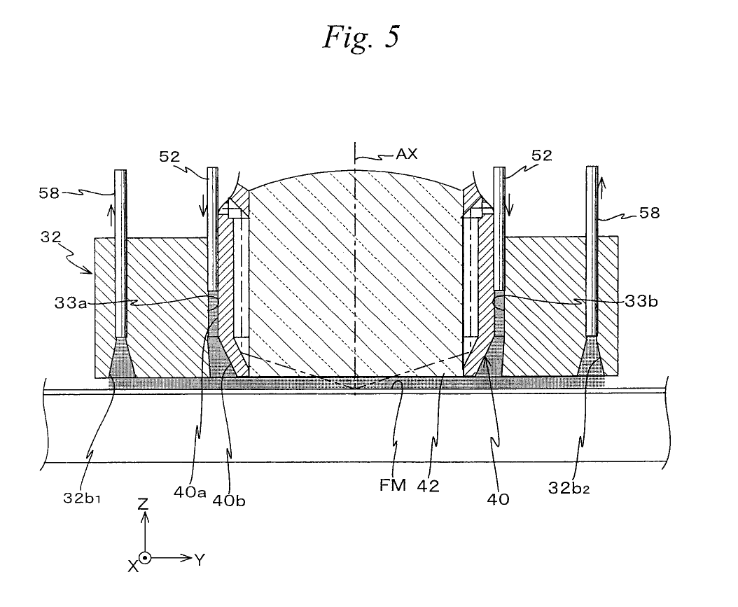

The other end of each of the supply pipes 52 connects to a supply pipe line 66, which has one end connecting to a liquid supply unit 74 and the other end connecting to supply pipes 52, respectively, via valves 62b. Liquid supply unit 74 is composed of parts including a liquid tank, a pressure pump, a temperature control unit, and the like and operates under the control of main controller 20. In this case, when liquid supply unit 74 is operated in a state where the corresponding valve 62a is open, for example, a predetermined liquid used for immersion whose temperature is controlled by the temperature control unit so that the temperature is about the same as that in a chamber (drawing omitted) where (the main body of) exposure apparatus 100 is housed is supplied to the space formed with liquid supply/drainage unit 32, lens 42, and the surface of wafer W, via each of the supply pipes 52 and liquid supply nozzles 33a and 33b. FIG. 5 shows a state where the liquid has been supplied in the manner described above.

Incidentally, in the description below, valves 62b arranged in each of the supply pipes 52 may also be considered together and referred to as a valve group 62b (refer to FIG. 7).

Incidentally, exposure apparatus 100 does not necessarily have to be equipped with all the units such as the liquid tank for supplying the liquid, the pressure pump, the temperature control unit, and the valves. At least a part of such units can be substituted with the equipment in the factory where exposure apparatus 100 is installed.

As the liquid referred to above, in this case, ultra pure water (hereinafter, it will simply be referred to as ‘water’ besides the case when specifying is necessary) that transmits the ArF excimer laser beam (light with a wavelength of 193.3 nm) is to be used. Ultra pure water can be obtained in large quantities at a semiconductor manufacturing plant or the like, and it also has an advantage of having no adverse effect on the photoresist on the wafer or to the optical lenses. Further, ultra pure water has no adverse effect on the environment as well as an extremely low concentration of impurities, therefore, cleaning action on the surface of the wafer and the surface of lens 42 can be anticipated.

Refractive index n of the water to the ArF excimer laser beam is substantially around 1.47. In this water, the wavelength of illumination light IL is reduced as follows:

193 nm×1/n=around 131 nm.

On the lower end surface of liquid supply/drainage unit 32, on the outside of both arc-shaped sections 33a and 33b, groove sections 32b₁ and 32b₂ that are shaped in half-arcs when viewed from below and have a predetermined depth are formed. The vicinities of the lower end of groove sections 32b₁ and 32b₂ are made to have a widening sectional shape when viewed from above (narrowing when viewed from below), and are liquid recovery nozzles. In the following description, these liquid recovery nozzles will be referred to as ‘liquid recovery nozzle 32b₁ and liquid recovery nozzle 32b₂,’ using the same reference numerals as groove sections 32b₁ and 32b₂.

On the bottom (upper) surface inside groove sections 32b₁ and 32b₂ of liquid supply/drainage unit 32, through holes are formed in the vertical direction arranged at a predetermined spacing, and into each of the through holes, one end of each of recovery pipes 58 is inserted from above. The other end of each of the recovery pipes 58 connects to a recovery pipe line 64, which has one end connecting to a liquid recovery unit 72 and the other end connecting to recovery pipes 58, respectively, via valves 62a. Liquid recovery unit 72 is composed of parts including a liquid tank, and a suction pump, and operates under the control of main controller 20. In this case, when the corresponding valve 62a is in an opened state, liquid recovery unit 72 recovers the water in the space formed with liquid supply/drainage unit 32, lens 42, and the surface of wafer W referred to earlier, via liquid recovery nozzles 32b₁ and 32b₂ and each of the recovery pipes 58. Hereinafter, valves 62a arranged in each of the recovery pipes 58 may also be considered together and referred to as a valve group 62a (refer to FIG. 7).

Incidentally, exposure apparatus 100 does not necessarily have to be equipped with all the units such as the tank for recovering the liquid, the suction pump, and the valves. At least a part of such units can be substituted with the equipment in the factory where exposure apparatus 100 is installed.

As the valves referred to above, adjustment valves (such as a flow control valve) or the like that open and close, and whose opening can also be adjusted are used. These valves operate under the control of main controller 20 (refer to FIG. 7).

Liquid supply/drainage unit 32 is fixed to the bottom section of barrel 40 by screws (not shown). And as is obvious from FIG. 3, in the state assembled to barrel 40, the bottom end surface of liquid supply/drainage unit 32 is flush with the lower surface of lens 42 (the lowermost surface of barrel 40). However, the present invention is not limited to this, and the lower end surface of liquid supply/drainage unit 32 can be set either higher or lower than the lower surface of lens 42.

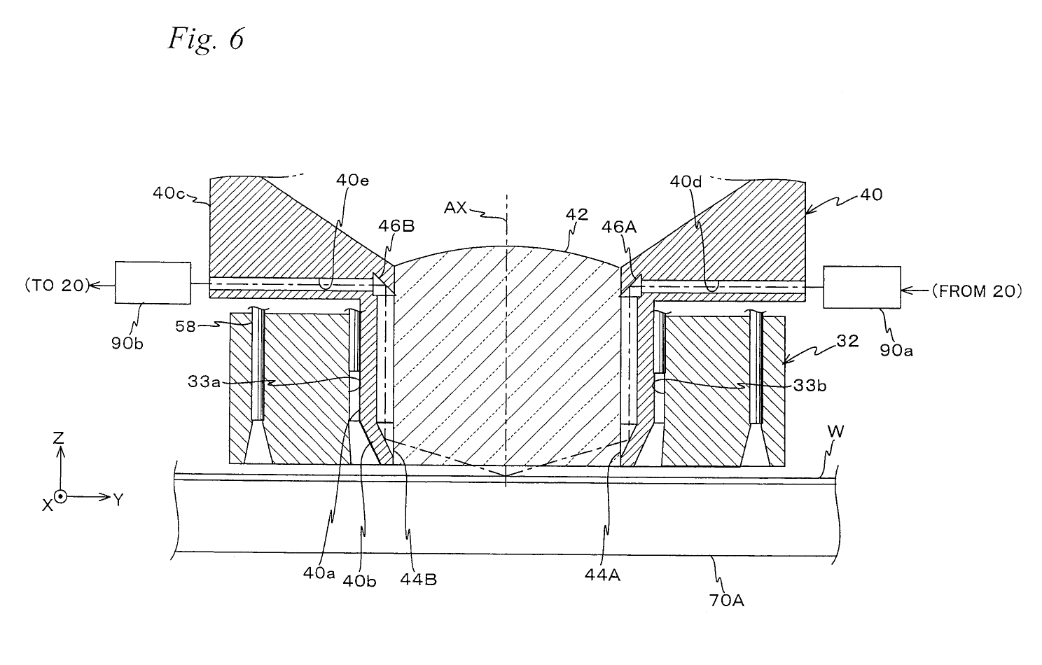

In exposure apparatus 100 of the embodiment, a focal point position detection system is also arranged for the so-called auto-focusing and auto-leveling of wafer W. The focal point position detection system will be described below, referring to FIG. 6.

In FIG. 6, a pair of prisms 44A and 44B, which is made of the same material as lens 42 and arranged in close contact with lens 42, is arranged between lens 42 and tapered section 40b of barrel 40.

Furthermore, in the vicinity of the lower end of a large diameter section 40c, which is the section excluding small diameter section 40a of barrel 40, a pair of through holes 40d and 40e is formed that extends in the horizontal direction and communicates the inside of barrel 40 with the outside. On the inner side (the space side referred to earlier) end of such through holes 40d and 40e, right angle prisms 46A and 46B are disposed, respectively, and fixed to barrel 40.

On the outside of barrel 40, an irradiation system 90a is disposed facing one of the through holes, 40d. Further, on the outside of barrel 40, a photodetection system 90b that constitutes the focal point position detection system with irradiation system 90a is disposed, facing the other through hole, 40e. Irradiation system 90a has a light source whose on/off is controlled by main controller 20 in FIG. 1, and emits imaging beams in the horizontal direction so as to form a large number of pinhole or slit images toward the imaging plane of projection optical system PL. The emitted imaging beams are reflected off right angle prism 46A vertically downward, and are irradiated on the surface of wafer W from an oblique direction against optical axis AX by prism 44A referred to earlier. Meanwhile, the beams of the imaging beams reflected off the surface of wafer W are reflected vertically upward by prism 44B referred to earlier, and furthermore, reflected in the horizontal direction by right angle prism 46B, and then received by photodetection system 90b. As is described above, in the embodiment, the focal position detection system is formed consisting of a multiple point focal position detection system based on an oblique method similar to the one disclosed in, for example, Kokai (Japanese Unexamined Patent Application Publication) No. 6-283403 and the corresponding U.S. Pat. No. 5,448,332, the system including irradiation system 90a, photodetection system 90b, prisms 44A and 44B, and right angle prisms 46A and 46B. The focal position detection system will be referred to as focal position detection system (90a, 90b) in the following description. As long as the national laws in designated states or elected states, to which this international application is applied, permit, the disclosures of the above publication and U.S. Patent are fully incorporated herein by reference.

Defocus signals, which are an output of photodetection system 90b of the focal position detection system (90a, 90b), are sent to stage controller 19 (refer to FIG. 7). Based on the defocus signals such as the S-curve signal from photodetection system 90b, stage controller 19 computes the Z position of the surface of wafer W and the θx and θy rotations when scanning exposure or the like is performed, and sends the computation results to main controller 20. Further, by controlling the movement of wafer table 30 in the Z-axis direction and the inclination in a two-dimensional direction (that is, rotation in the θx and θy directions) so that the difference between the Z position of the surface of wafer W and the θx and θy rotations that has been computed and their target values becomes zero, or in other words, the defocus becomes zero, stage controller 19 performs auto-focusing (automatic focusing) and auto-leveling in which the imaging plane of projection optical system PL and the surface of wafer W are made to substantially coincide with each other within the irradiation area (the area optically conjugate with the illumination area described earlier (exposure quantity area)) of illumination light IL. As is proposed in, for example, Japanese Patent Application No. 2003-367041, a part of liquid supply/drainage unit 32 can be made of glass transparent to the light from the light source in the focal position detection system (90a, 90b), and the focal position detection system (90a, 90b) can perform the detection previously described using the glass.

Further, regarding the X, Y, and Z positions of wafer table 30, correction of thrust instruction values is performed by feedforward control so that the influence by positional deviation or control delay of wafer W or the fiducial marks caused by the supply of wafer onto wafer table 30 is suppressed as much as possible. Details on the operation will be described later in the description.

FIG. 7 is a block diagram of an arrangement of a control system of exposure apparatus 100, with the arrangement partially omitted. The control system is mainly composed of main controller 20, which is made up of a workstation (or a microcomputer) or the like, and stage controller 19, which operates under the control of main controller 20.

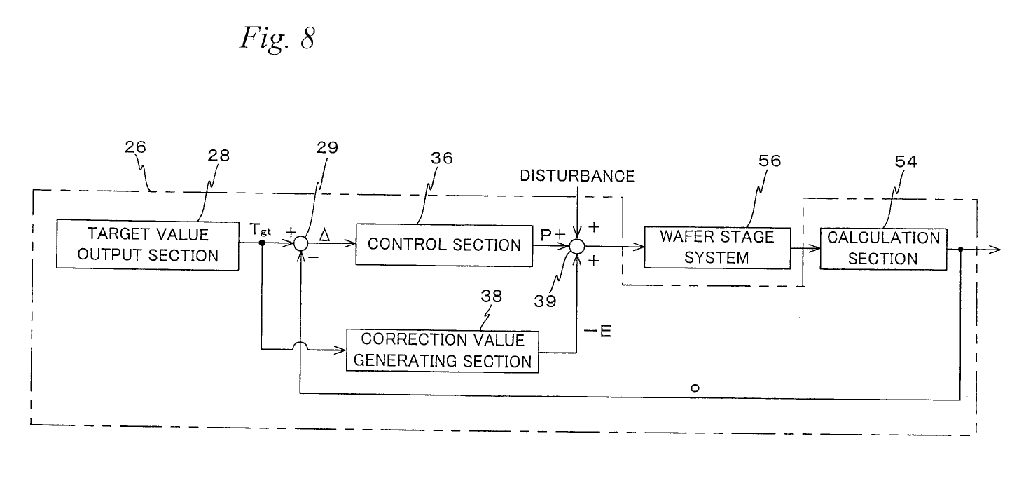

FIG. 8 is a block diagram of a wafer stage control system 26 installed in stage controller 19, along with a wafer stage system 56, which serves as the object subject to control. As is shown in FIG. 8, wafer stage control system 26 is composed including a target value output section 28, a substracter 29, a control section 36, a correction value generating section 38, an adder 39, a calculation section 54 and the like.

In response to instructions from main controller 20, target value output section 28 makes a position command profile with respect to wafer table 30, generates a position command per unit time in the profile, or in other words, generates a target value T_{gt}(=(X, Y, 0, 0, 0, 0)) for the position of wafer table 30 in directions of six degrees of freedom, which are X, Y, Z, θx, θy, and θz, and outputs the values to both substracter 29 and correction value generating section 38.

Substracter 29 calculates positional deviation Δ(=(Δₓ=X−x, Δ_{y}=Y−y, Δ_{z}=0−z, Δθₓ=0−θₓ, Δθ_{y}=0−θ_{y}, Δθ_{z}=0θ_{z})), which is the difference between target value T_{gt} in directions of each degree of freedom and the actual measurement values (observed value o=(x, y, z, θx, θy, and θz)) of wafer table 30 in directions of each degree of freedom.

Control section 36 is composed including a PI controller and the like that individually performs, for example, (proportional+integral) control operations in directions of each degree of freedom with positional deviation A output from substracter 29 serving as an input, and generates a command value P(=(Pₓ, P_{y}, P_{z}, Pθₓ, Pθ_{y}, Pθ_{z})) for thrust in directions of each degree of freedom with respect to wafer stage system 56 as an operation amount.

Adder 39 adds in directions of each degree of freedom command value P for thrust from control section 36 and a correction value −E(=(−Eₓ, −E_{y}, −E_{z}, 0, 0, 0)) for thrust, which is an output from correction value generating section 38 (to be described later in the description), and outputs a thrust command (P+(−E))=(Pₓ−Eₓ, P_{y}−E_{y}, P_{z}−E_{z}, Pθₓ, Pθ_{y}, Pθ_{z})) to wafer stage system 56.

Wafer stage system 56 is a system that corresponds to the object subject to control in wafer stage control system 26, and is a system that inputs the thrust command output from adder 39 and outputs the positional information of wafer table 30. More specifically, wafer stage system 56 substantially corresponds to wafer stage drive section 24 to which thrust command output from adder 39 is given, wafer table 30 driven in directions of six degrees of freedom by wafer stage drive section 24, and a position measuring system for measuring the position of wafer table 30, that is, wafer interferometer 18 and the focal position detection system (90a, 90b).

Wafer stage drive section 24 is composed including a conversion section for converting thrust command (P+(−E)) into an operation amount with respect to each actuator when thrust command (P+(−E)) is given.

Calculation section 54 computes the positional information of wafer table 30 in the X-axis, Y-axis, and θz directions based on the measurement values of wafer interferometer 18, which is the output of the position measuring system, as well as the positional information of wafer table 30 in the Z-axis, θx, and θy directions based on the output of the focal position detection system (90a, 90b), which is also the output of the position measuring system. The positional information of wafer table 30 on the directions of six degrees of freedom computed by calculation section 54 is supplied to main controller 20. Further, during scanning exposure (to be described later), the positional information of wafer table 30 within an X plane and a Y plane calculated by calculation section 54 is input to a synchronous position calculation section (not shown), and the synchronous position calculation section provides a position target value with respect to the reticle stage control system (not shown).

In correction value generating section 38, other than the target value T_{gt} of the position from target value output section 28, values of flow Q and a contact angle θ, which are setting conditions, are input from main controller 20. And, based on equations (3), (4), and (5) below, correction value generating section 38 computes X-direction error Eₓ′, Y-direction error E_{y}′, and Z-direction error E_{z}′ respectively, converts the computed results into correction values −Eₓ, −E_{y}, and −E_{z} for thrust by a predetermined conversion calculation, and performs feedforward input of the conversion to adder 39.

Eₓ′=f(X, Y, Vₓ, V_{y}, Q, θ) (3)

E_{y}′=g(X, Y, Vₓ, V_{y}, Q, θ) (4)

E_{z}′=h(X, Y, Vₓ, V_{y}, Q, θ) (5)

Parameters X and Y in equations (3), (4), and (5) above are command values for the position of wafer stage WST from target value output section 28, parameters Vₓ and V_{y} are the moving velocity of wafer stage WST (this is computed based on the difference between the i^{th} command values Xᵢ, Yⱼ and the (i+1)^{th} command values Xᵢ₊₁, Yᵢ₊₁, and on sampling intervals Δt), parameter Q is the flow of the water supplied, and parameter θ is the contact angle of the water with respect to the wafer (the resist or the coating layer on the wafer).

The reason why parameters X and Y are included in equations (3), (4), and (5) above is because forces such as the pressure and the surface tension due to the supply of water act on wafer W, wafer table 30 and the like, and when the position of wafer stage WST on the stage coordinate system differs, the change in the shape of the surface of wafer table 30 caused by the forces described above differs.

Further, parameters X and Y are included for the following reason. More specifically, when wafer table 30 moves in a predetermined direction within the XY plane, a flow of the water according to the moving direction and the moving velocity is generated. This flow is a viscous Couette flow that is generated when shear force due to relative displacement of the surface of the wafer and the lower surface of lens 42 is applied to the water, which is an incompressible viscous fluid as well as a Newtonian fluid that obeys Newton's law of viscosity. That is, the moving velocity of wafer table 30 is one of the parameters that decide the flow of the water, or as a consequence decide the pressure of the water.

Further, the reason why parameter Q is included is because the flow of the water supplied is one of the parameters that decide the pressure of the water.

Further, the reason why parameter θ (contact angle θ) is included for the following reason.

In the contact between a solid substance (e.g. a wafer) and a liquid substance (e.g. water), when the surface tension of the solid substance (surface energy) is expressed as γₛ, the solid-liquid interfacial tension (the interfacial energy between the solid-liquid interface) is expressed as γ_{SL}, and the surface tension of the liquid substance (surface energy) is expressed as γ_{L}, then, contact angle θ can be expressed in Young's equation as in equation (6) below.

γ_{L}·cos θ=(γ_{S}−γ_{SL}) (6)

As is shown above, because there is a predetermined relation between surface tension γ_{L} of the water, which is a part of the force acting on the wafer table and the wafer, and contact angle θ, the contact angle is included as a parameter that affects the surface tension. The contact angle can be obtained, for example, by visual observation or by image measuring.

In the embodiment, equations (3), (4), and (5) described above are obtained in advance, based on the results of measuring exposure (test exposure) actually performed using exposure apparatus 100. The details on this are described in the description below.

As a premise, a measurement reticle (hereinafter referred to as ‘measurement reticle R_{T}’ for the sake of convenience) should be loaded on reticle stage RST. Further, wafer stage WST should be at a wafer exchange position, and a measurement wafer (hereinafter referred to as ‘measurement wafer W_{T}’ for the sake of convenience) should be loaded on wafer holder 70.

In this case, as measurement reticle R_{T}, for example, a reticle is used, which is made of a rectangular-shaped glass substrate that has a pattern area formed on one surface (pattern surface) in which a plurality of measurement marks are arranged at a predetermined distance formed in a matrix shape. Further, on measurement reticle R_{T}, a plurality of reticle alignment marks are formed in pairs. Also, on measurement reticle R_{T}, wafer marks (alignment marks) whose positional relation with the center of the pattern area is known are arranged. These wafer marks are transferred onto the wafer with the measurement marks on scanning exposure, which is performed in the process of manufacturing measurement wafer W_{T}.

Further, as measurement wafer W_{T}, a wafer on which the pattern of measurement reticle R_{T} is transferred on a plurality of shot areas using a projection exposure apparatus having high precision (an exposure apparatus that preferably does not employ the immersion method) that constitutes a device manufacturing line and where images of a plurality of measurement marks (e.g. a resist image or an etched image) are formed in each shot area is used. In each shot area of measurement wafer W_{T}, an alignment mark (wafer mark) is arranged. Further, a photoresist is coated on the surface of measurement wafer W_{T} by a coater/developer (C/D) (not shown). Incidentally, measurement wafer W_{T} should be the sample for making the functions in equations (3), (4), and (5) previously described, and the images of the measurement marks already formed should be the datum for the positional deviation amount that are measured in order to make the functions.

Incidentally, positional deviation amount (dx, dy) of the images of each of the measurement marks of measurement wafer W_{T} already formed from the designed formation position should be obtained in advance, and should be stored in a memory (not shown).

Next, reticle alignment is performed in a procedure similar to a typical scanning stepper. However, in exposure apparatus 100 of the embodiment, because illumination light IL is used as the detection beam for alignment, reticle alignment is performed in a state where the water is supplied to the space between lens 42 located on the edge on the image plane side of projection optical system PL and fiducial mark plate FM.

More specifically, according to instructions from main controller 20, stage controller 19 moves reticle stage RST via reticle stage drive section 11 based on the measurement values of reticle interferometer 16, so that the substantial center of the illumination area of the illumination light by illumination system 10 coincides with the substantial center of measurement reticle R_{T}. Stage controller 19 also moves wafer table 30 via wafer stage drive section 24 based on the measurement values of wafer interferometer 18 to a position (hereinafter referred to as ‘a predetermined datum position’) where fiducial mark plate FM is positioned, at the projection position of the pattern of measurement reticle R_{T} by projection optical system PL.

Next, main controller 20 begins the operation of liquid supply unit 74, and also opens each valve in valve group 62b to a predetermined degree. According to this operation, the water is supplied from all supply pipes 52 via liquid supply nozzles 33a and 33b of liquid supply/drainage unit 32, and after a predetermined period of time has passed, the space between lens 42 and the surface of fiducial mark plate FM is filled with the water which has been supplied. Then, main controller 20 opens each valve in valve group 62a to a predetermined degree, and recovers the water that flows outside from below lens 42 in liquid recovery unit 72, via liquid recovery nozzles 32b₁ and 32b₂ and each of the recovery pipes 58. This state is shown in FIG. 5.

Main controller 20 adjusts the degree of opening of each valve in valve group 62b and valve group 62a while reticle alignment is performed so that the flow of the water supplied per unit time and the flow of the water recovered is substantially the same. Accordingly, a constant amount of water is held in the space between lens 42 and fiducial mark plate FM. Further, in this case, because the space between lens 42 and fiducial mark plate FM is around 1 mm at a maximum, the water is held in the space between liquid supply/drainage unit 32 and fiducial mark plate 32 by its surface tension, therefore, the water hardly leaks outside liquid supply/drainage unit 32.

When the supply of water begins in the manner described above and the space between lens 42 and fiducial mark plate FM is filled with the water that has been supplied, main controller 20 detects the relative position between a first fiducial mark in pairs on fiducial mark plate FM and the reticle alignment mark in pairs on measurement reticle R_{T} corresponding to the first fiducial mark, using reticle alignment detection system 12 also in pairs. Then, main controller 20 stores the detection results of reticle alignment detection system 12 and the positional information of reticle stage RST within the XY plane and the positional information of wafer table 30 within the XY plane at the time of detection in the memory, which are obtained via stage controller 19. Next, main controller 20 moves both wafer stage WST and reticle stage RST oppositely for only a predetermined distance along the Y-axis direction, and then detects the relative position between another first fiducial mark in pairs on fiducial mark plate FM and another reticle alignment mark in pairs on measurement reticle R_{T} corresponding to the first fiducial mark, using reticle alignment detection system 12. Then, main controller 20 stores the detection results of reticle alignment detection system 12 and the positional information of reticle stage RST within the XY plane and the positional information of wafer table 30 within the XY plane at the time of detection in the memory, which are obtained via stage controller 19. Further, in the manner described above, the relative positional relation between still another first fiducial mark in pairs on fiducial mark plate FM and the reticle alignment mark in pairs on measurement reticle R_{T} corresponding to the first fiducial mark can be further measured.

Then, main controller 20 obtains the relative positional relation between a reticle stage coordinate system set by the measurement axes of reticle interferometer 16 and a wafer stage coordinate system set by the measurement axes of wafer interferometer 18, using the relative positional information between at least the two sets of the first fiducial mark in pairs and the corresponding reticle alignment marks obtained in the manner described above and the positional information of reticle stage RST within the XY plane and the positional information of wafer table 30 within the XY plane at the time of each measurement. And, this operation completes the reticle alignment. In the scanning exposure, which will be described later in the description, scanning exposure is performed by synchronously scanning reticle stage RST and wafer stage WST in the Y-axis direction of the wafer stage coordinate system, and when scanning exposure is performed, reticle stage RST will be scanned, based on the relative positional relation between the reticle stage coordinate system and the wafer stage coordinate system.

When reticle alignment is completed in the manner described above, baseline measurement of alignment system AS is performed. In the embodiment, however, prior to the baseline measurement, main controller 20 closes each valve of valve group 62b and stops the supply of water in a state where fiducial mark plate FM is directly under projection unit PU. At this point, the valves in valve group 62a are still open. Accordingly, the water continues to be recovered by liquid recovery unit 72. And, when liquid recovery unit 72 recovers almost all the water on fiducial mark plate FM, main controller 20 moves wafer table 30 back to the predetermined datum position, and then moves wafer table 30 from the position by a predetermined distance, such as a design value of the baseline, within the XY plane, and detects a second fiducial mark on fiducial mark plate FM, using alignment system AS. Then, based on the information on the relative positional relation between the detection center and the second fiducial mark obtained in the detection above and the information on the relative positional relation between the first fiducial mark in pairs and the corresponding reticle alignment marks measured when wafer table 30 is positioned at the datum position, the positional information of wafer table 30 within the XY plane on each measurement, the design values of the baseline, and the positional relation between the first fiducial mark and the second fiducial mark already known, main controller 20 computes the baseline of alignment system AS, or in other words, the distance (positional relation) between the projection center of the reticle pattern and the detection center (index center) of alignment system AS.

By using the baseline obtained in the manner described above with the array coordinates of the shot areas on the wafer, which will be obtained as the results of wafer alignment by the EGA method described later in the description, it should be possible to align the shot areas to the projection position of the reticle pattern without fail.

However, in the embodiment, since the measurement results of the information on the relative positional relation between the first fiducial mark in pairs and the corresponding reticle alignment marks, which serve as the base for baseline computation, include the positional deviation errors of the first fiducial mark in pairs due to the deformation of wafer table 30 due to the supply of water on reticle alignment, the errors have to be corrected in the baseline. These errors are values corresponding to the pressure and surface tension of the water, however, in the embodiment, a simulation is performed in advance, and positional deviation δX, δY of the first fiducial mark in pairs is obtained and stored in the memory.

Then, when the measurement of the baseline described above is completed, main controller 20 then stores the baseline after correction whose measured baseline has been corrected by the correction values described above as an updated baseline in the memory.

Next, wafer alignment such as EGA (Enhanced Global Alignment) is performed on measurement wafer W_{T} that has been loaded. More specifically, main controller 20 sequentially performs position setting of wafer table 30 via stage controller 19 and wafer stage drive section 24, so that the wafer marks respectively arranged in a specific plurality of shot areas (sample shot areas) selected from a plurality of shot areas already formed on wafer W_{T} are sequentially positioned within the detection field of alignment system AS. Main controller 20 detects the wafer mark with alignment system AS each time the position setting is performed.

Next, based on the position of the wafer marks with respect to the index center and the positional information of wafer table 30 within the XY plane, which are the detection results of the wafer marks, main controller 20 computes the position coordinates of each wafer mark on the wafer coordinate system. Then, main controller 20 performs a statistical calculation using the calculated position coordinates of the wafer marks by the least squares method disclosed in, for example, Kokai (Japanese Unexamined Patent Application Publication) No. 61-44429 and the corresponding U.S. Pat. No. 4,780,617, and computes the parameters of a predetermined regression model such as the rotational component, scaling component, offset component of the array coordinate system of each shot area on measurement wafer W_{T} and the wafer stage coordinate system, the orthogonal degree component of the X-axis and Y-axis in the wafer stage coordinate system and the like. Main controller 20 then substitutes the parameters into the regression model, computes the array coordinates of each shot area on measurement wafer W_{T}, or more specifically, the position coordinates of the center of each shot area, and stores the results in the memory (not shown). The position coordinates of the center of each shot area calculated at this point will be used when associating the measurement results of the measurement wafer with the wafer stage coordinate system. Details on this will be described later in the description.

As long as the national laws in designated states or elected states, to which this international application is applied, permit, the disclosures of the above publication and U.S. Patent are fully incorporated herein by reference.

When the alignment described above is completed, according to instructions from main controller 20, stage controller 19 then moves reticle stage RST to the scanning starting position (acceleration starting position) based on the measurement values of reticle interferometer 16, as well as moves wafer stage WST to a water supply starting position, e.g. the position where fiducial mark FM is positioned directly under projection unit PU, based on the measurement values of wafer interferometer 18. Next, main controller 20 begins to operate liquid supply unit 74 and opens each valve in valve group 62b to a predetermined degree as well as opens each valve in valve group 62a to a predetermined degree. Main controller 20 further begins to operate liquid recovery unit 72, and begins to supply the water into the space between lens 42 and the surface of fiducial mark plate FM while recovering the water from the space. In this case, main controller 20 adjusts the degree of opening of each valve in valve group 62b and valve group 62a so that the flow of the water supplied per unit time and the flow of the water recovered is substantially the same.

Then, exposure operation by the step-and-scan method is performed in the following manner.

First of all, based on the results of wafer alignment and the baseline measurement results, main controller 20 instructs stage controller 19 to move wafer stage WST. According to the instructions, stage controller 19 moves wafer stage WST (wafer table 30) to the scanning starting position (acceleration starting position) for exposing the first shot (the first shot area) of measurement wafer W_{T}, while monitoring the measurement values of wafer interferometer 18.

The scanning starting position (acceleration starting position) should be a position where the center position coordinate of the shot area to be transferred and formed by the scanning exposure is shifted, for example, by a predetermined distance (e.g. w) in the X-axis direction from the center position coordinate of the first shot obtained in the wafer alignment described above. The reason for this is because by keeping the image of the mark transferred and formed by the scanning exposure from overlapping the resist images of the marks already formed on measurement wafer W_{T}, the measurement of positional deviation (to be described later) can be smoothly performed.

When wafer stage WST is moved from the water supply starting position, main controller 20 continues the water supply and recovery in the manner previously described.

When measurement wafer W_{T} has been moved to the acceleration starting position described above, according to instructions from main controller 20, stage controller 19 then begins the relative scanning of reticle stage RST and wafer stage WST in the Y-axis direction.

This relative scanning is performed by wafer stage control system 26 and the reticle stage control system, which controls reticle stage RST based on the position target value computed by the synchronous position calculation section according to the positional information of wafer table 30 within the X plane and the Y plane calculated by calculation section 54 in wafer stage control system 26.

However, at this stage of measurement exposure, correction value generating section 38 outputs (0, 0, 0, 0, 0, 0, 0) as correction values. That is, correction value generating section 38 does not perform correction.

Then when both stages RST and WST reach their target scanning speeds, illumination light IL begins to illuminate the pattern area of measurement reticle R_{T} and scanning exposure begins. During this scanning exposure, stage controller 19 performs synchronous control of both stages RST and WST in which moving velocity Vr of reticle stage RST in the Y-axis direction and moving velocity Vw(=V_{y}) of wafer stage WST in the Y-axis direction are maintained at a velocity ratio corresponding to the projection magnification of projection optical system PL.

Then, different areas of the pattern area of measurement reticle R_{T} are sequentially illuminated, and when illumination of the entire surface of the pattern area has been completed, the scanning exposure of the first shot on measurement wafer W_{T} is terminated. By the operation described above, the pattern of measurement reticle R_{T} is reduced and transferred onto the first shot on measurement wafer W_{T} via projection optical system PL and the water.

When performing scanning exposure of the first shot on measurement wafer W_{T} described above, main controller 20 adjusts the degree of opening of each valve constituting valve groups 62a and 62b so that a water flow that moves from the rear side of projection unit PU to the front side is created under lens 42, in the scanning direction, or in other words, the moving direction of measurement wafer W_{T}. More specifically, main controller 20 adjusts the degree of opening of each valve constituting valve groups 62a and 62b so that in the moving direction of measurement wafer W_{T}, the total amount of the water supplied from supply pipes 52 on the rear side of projection unit PU is greater than the total amount of the water supplied from supply pipes 52 on the front side of projection unit PU by ΔQ, while corresponding to this, in the moving direction of measurement wafer W_{T}, the total amount of the water recovered via recovery pipes 58 on the front side of projection unit PU is greater than the total amount of the water recovered via recovery pipes 58 on the rear side of projection unit PU by ΔQ.

Further, in the scanning exposure described above, because exposure has to be performed in a state where the illumination area on measurement wafer W_{T} coincides as much as possible with the imaging plane of projection optical system PL, stage controller 19, or to be more precise, wafer stage control system 26 performs auto-focus and auto-leveling based on the output of the focal position detection system (90a, 90b).

When the scanning exposure of the first shot on measurement wafer W_{T} is finished in the manner described above, stage controller 19 steps wafer stage WST in the X-axis and Y-axis directions via wafer stage drive section 24 according to instructions from main controller 20, and wafer stage WST is moved to the acceleration starting position for exposing a second shot (a second shot area) on measurement wafer W_{T}. In this case, as in the first shot, the scanning starting position should be a position where the center position coordinate of the shot area to be transferred and formed by the scanning exposure is shifted by w in the X-axis direction from the center position coordinate of the second shot obtained in the wafer alignment described above.

On the stepping operation in between shots of wafer stage WST between the exposure of the first shot and the exposure of the second shot, main controller 20 performs the open/close operation of each valve similar to the operation performed in the case when wafer table 30 is moved from the water supply starting position to the acceleration starting position for exposing the first shot.

Next, under the control of main controller 20, scanning exposure is performed on the second shot on measurement wafer W_{T} in the same manner as the scanning exposure previously described. In the case of the embodiment, because the so-called alternate scanning method is employed, the scanning direction (moving direction) of reticle stage RST and wafer stage WST will be opposite to the first shot when exposing the second shot. The processing performed by main controller 20 and stage controller 19 on scanning exposure of the second shot is basically same as the description above. In this case as well, main controller 20 adjusts the degree of opening of each valve constituting valve groups 62a and 62b so that a water flow that moves from the rear side of projection unit PU to the front side is created under lens 42, in the moving direction of measurement wafer W_{T} opposite to the direction when exposing the first shot.

In the manner described above, scanning exposure of the m^{th} (m is a natural number) shot area on measurement wafer W_{T} and the stepping operation for exposing the m+1^{th} shot area are repeatedly performed, and the pattern of measurement reticle R_{T} is sequentially transferred onto all the shot areas subject to exposure on measurement wafer W_{T}.

With the operation above, test exposure of a wafer is completed, and a plurality of shot areas on which the pattern of measurement reticle R_{T} is transferred is formed on measurement wafer W_{T}.

In the embodiment, measurement exposure using measurement reticle R_{T} as in the description above is performed on different measurement wafers, while individually making various changes in the conditions closely related to each parameter in equations (3), (4), and (5) described above, such as the scanning speed, the flow of water supplied, the type of resist or coating film coated on the wafer, and the like.

Then, the measurement wafers that have been exposed are each carried to the coater/developer (not shown) and are developed. And after the development, the resist images formed in each of the shot areas on each measurement wafer are measured with an SEM (Scanning Electron Microscope) or the like, and based on the measurement results, the positional deviation amount (X-axis direction, Y-axis direction) of each measurement mark is obtained for each measurement wafer.

Positional deviation amount (eX, eY) of each measurement mark from the design value can be obtained by the following procedure.

First of all, from the position coordinate of the resist image of each measurement mark formed in the current process, the position of the resist image of the corresponding mark formed in the original process (already formed on the measurement wafer) is subtracted. And, by further subtracting w regarding the X-axis direction, positional deviation amount (DX, DY) of each measurement mark is obtained, with the position of the resist image of the measurement mark already formed on the measurement wafer serving as a datum.

In this case, because the position of the image of each measurement mark already formed on the measurement wafer serving as a datum is shifted by (dx, dy) from the designed forming position, positional deviation amount (dx, dy) is retrieved from the memory. And, based on the deviation amount and positional deviation amount (DX, DY) obtained above, positional deviation amount (eX, eY) of each measurement mark from the design value (the designed forming position) is computed.

Next, for each measurement wafer, positional deviation amount (eX, eY) of each measurement mark is correlated with the wafer stage coordinate system (X, Y) on the basis that the center coordinate of each shot area on the wafer coordinate system set on the measurement wafer and the center coordinate of each shot area obtained as the results of the EGA performed earlier coincide with each other.

Further, because the conditions under which the measurement exposures were performed are known for each measurement wafer, equations (3) and (4) previously described are determined by performing a curve fit using the least squares method approximation, using positional deviation amount (eX, eY) of all the measurement marks obtained in all the measurement wafers, coordinate values (X, Y) of the corresponding measurement marks, and the setting values that have been set (in this case, velocity V_{y}(=Vw), flow Q, and contact angle θ). Incidentally, because data obtained from the measurement exposures are data during scanning exposure, therefore, normally, Vₓ=0. In the case, however, the purpose is correction or the like of C-distortion or the like in the shot area, Vₓ should be a variable that changes according to the function of position Y (or a variable that changes according to the function of time t).

Further, for example, based on measurement results of the line width of the transferred image (resist image) of all the measurement marks on all the measurement wafers that have been obtained and the CD-focus curve (a curve that shows the relation between line width and focus) that has been obtained in advance, the line width of the transferred image of each mark is converted into a defocus amount, or in other words, a positional deviation amount eZ of the mark in the Z-axis direction. Then, equation (5) previously described is determined by performing a curve fit using the least squares method approximation, using positional deviation amount eZ of all the measurement marks obtained in all the measurement wafers, coordinate values (X, Y) of the corresponding measurement marks, and the setting values. Besides this method, defocus amount (i.e. the positional deviation amount of the mark in the Z-axis direction) eZ can also be computed by obtaining the deviation of the transferred position of the transferred image of the measurement mark formed on the measurement wafer from its datum position, using a measurement reticle on which measurement marks whose diffraction efficiency of positive and negative diffracted lights of the same order differs are formed. Incidentally, the best focus position of projection optical system PL may be obtained by sequentially transferring the pattern of measurement reticle R_{T}, while sequentially changing the position of wafer table 30 in the Z-axis direction.

As a matter of course, other than the methods based on the results of measurement exposure described above, it is possible to decide equations (3), (4), and (5) previously described, based on results of a simulation, which is performed by individually changing various conditions closely related to each parameter of equations (3), (4), and (5) described above, such as the scanning velocity, the flow of the water supplied, and the type of resist or coating layer coated on the wafer.

In any case, equations (3), (4), and (5) previously described, which are the equations decided for calculating the deviation amount, are stored in an internal memory of stage controller 19. Further, in the internal memory of stage controller 19, a conversion equation for converting the positional deviation amount to a thrust command value is also stored. And, these equations are used in correction value generating section 38.

Next, the exposure operation when manufacturing a device with exposure apparatus 100 of the embodiment will be described.

Also in this case, a series of processing is basically performed according to a procedure the same as in the measurement exposure previously described. Therefore, in order to prevent redundant explanation, the description below will focus on the different points.

In this case, instead of measurement reticle R_{T}, a device reticle R on which a device pattern is formed is used, and instead of measurement reticle W_{T}, a wafer W whose surface is coated with a photoresist and has a circuit pattern already transferred on at least one layer is used.

In the same procedure as in the earlier description, alignment of reticle R, baseline measurement of alignment system AS, and wafer alignment of wafer W by the EGA method are preformed. On these operations of reticle alignment, baseline measurement, and wafer alignment, main controller 20 performs the water supply and recovery operations the same as in the previous description.

When the wafer alignment described above is completed, based on instructions from main controller 20, stage controller 19 moves reticle stage RST to the scanning starting position (acceleration starting position) based on the measurement values of reticle interferometer 16, and also moves wafer stage WST to a predetermined water supply starting position, e.g. the position where fiducial mark FM is positioned directly under projection unit PU, based on the measurement values of wafer interferometer 18.

Next, main controller 20 begins the operation of liquid supply unit 74, opens each valve in valve group 62b to a predetermined degree, and also opens each valve in valve group 62a to a predetermined degree. Further, main controller 20 starts the operation of liquid recovery unit 72, and starts the water supply to the space between lens 42 and the surface of fiducial mark plate FM and the water recovery from the space. At this point, main controller 20 adjusts the degree of opening of each valve in valve group 62b and valve group 62a so that the flow of the water supplied per unit time and the flow of the water recovered is substantially the same.

Then, exposure operation by the step-and-scan method is performed in the manner described below.

First of all, based on the wafer alignment results and the baseline measurement results, main controller 20 instructs stage controller 19 to move wafer sage WST. And, according to the instructions, main controller 19 moves wafer stage WST (wafer table 30) to the scanning starting position (acceleration starting position) for exposing the first shot (the first shot area) of wafer W, while monitoring the measurement values of wafer interferometer 18.

More specifically, the target value output section computes the acceleration starting position for exposure of the first shot area (the first shot), based on the position coordinates of the first shot area on the stage coordinate system obtained by the wafer alignment previously described and the new baseline also described earlier. And then, based on the acceleration starting position and the current position of wafer table 30, the target value output section makes a position command profile with respect to wafer table 30, and generates a position command per unit time in the profile, or in other words, a target value T_{gt}(=(X, Y, 0, 0, 0, 0)) for the position of wafer table 30 in directions of six degrees of freedom, which are X, Y, Z, θx, θy, and θz, and outputs the values to both substracter 29 and correction value generating section 38.

By this operation, control section 36 performs control operation based on positional deviation Δ(=(Δₓ, Δ_{y}, Δ_{z}, Δθₓ, Δθ_{y}, Δθ_{z})), which is the difference between the actual measurement values (observed value o=(x, y, z, θx, θy, θz)) of wafer table 30 in directions of each degree of freedom output from substracter 29, and outputs command value P(=(Pₓ, P_{y}, P_{z}, Pθₓ, Pθ_{y}, Pθ_{z})) for thrust in directions of each degree of freedom with respect to wafer stage system 56 to adder 39. However, since the focal position detection system (90a, 90b) is turned off besides the time when relative scanning of wafer table 30 with respect to reticle stage RST is performed, observed values θx, θy, and θz are all zero, the corresponding target values are also all zero, therefore, positional deviations Δθₓ, Δθ_{y}, and Δθ_{z} are also zero. Accordingly, command values Pθₓ, Pθ_{y}, and Pθ_{z} for thrust are also zero.

Based on target value T_{gt} of the position from target value output section 28 and values of flow Q and contact angle θ input from main controller 20, correction value generating section 38 computes X-direction error Eₓ′, Y-direction error E_{y}′, and Z-direction error E_{z}′ respectively, by equations (3), (4), and (5) described earlier, and converts the computed results into correction values −Eₓ, −E_{y}, and −E_{z} for thrust by a predetermined conversion calculation. Then, correction value generating section 38 performs feedforward input of correction value −E(=−Eₓ, −E_{y}, −E_{z}, 0, 0, 0) to adder 39.

Adder 39 adds command value P for thrust from control section 36 and the correction value −E for thrust output from correction value generating section 38 in directions of each degree of freedom, and provides wafer stage drive section 24 that makes up wafer stage system 56 thrust command (P+(−E))=(Pₓ−Eₓ, P_{y}−E_{y}, P_{z}−E_{z}, Pθₓ, Pθ_{y}, Pθ_{z})). However, command values Pθ_{X}, Pθ_{y}, and Pθ_{z} for thrust are zero besides when relative scanning of wafer table 30 with respect to reticle stage RST is performed.

In wafer stage drive section 24, the conversion section converts thrust command (P+(−E)) into the operation amount with respect to each actuator, and the actuators drive wafer table 30 indirections of six degrees of freedom.

As is described so far, by target value output section 28 outputting position command per unit time in the position command profile to wafer table 30 to both substracter 29 and correction value generating section 38 for each unit time, control operations as the description above are repeatedly performed, and wafer table 30 is moved to the scanning starting position (acceleration starting position) for exposing the first shot (the first shot area) of wafer W.

Then, based on instructions from main controller 20, target value output section 28 makes the position command profile to wafer table 30 corresponding to the target scanning speed on exposure of the first shot, and by outputting the position command per unit time in the position command profile to both substracter 29 and correction value generating section 38 for each unit time, acceleration of wafer table 30 begins, and at the same time, acceleration of reticle stage RST begins by the reticle stage control system, based on the position target values computed by the synchronous position calculation section previously described.

Then, when stages RST and WST both reach their target scanning speeds, illumination light IL begins to irradiate the pattern area of reticle R, and scanning exposure begins. During this scanning exposure, synchronous control of the stages RST and WST is performed by stage controller 19 so that moving speed Vr of reticle stage RST in the Y-axis direction and moving speed Vw(=V_{y}) of wafer stage WST in the Y-axis direction are maintained at a speed ratio corresponding to the projection magnification of projection optical system PL.

Then, different areas in the pattern area of reticle R are sequentially illuminated by illumination light IL, and when the entire pattern area has been illuminated, scanning exposure of the first shot on wafer W is completed. By this operation, the pattern of reticle R is reduced and transferred onto the first shot of wafer W via projection optical system PL and the water. While the relative scanning of wafer table 30 and reticle stage RST described above is performed, the open/close operation or the like of each of the valves in valve groups 62a and 62b is performed in completely the same manner as in the measurement exposure previously described.

In this case, however, correction value generating section 38 of wafer stage control system 26 performs feedforward input of correction values (−Eₓ, −E_{y}) to adder 39, and wafer table 30 (wafer stage WST) is driven by wafer stage drive section 24 based on thrust command values, which are thrust command values (Pₓ, P_{y}) output from control section 36 that have been corrected by the correction values. Therefore, the pattern of reticle R is transferred onto the shot areas subject to exposure with good overlay accuracy in a state where the positional deviation of the shot area subject to exposure on wafer W in the X-axis direction and the Y-axis direction due to the supply of water, or more specifically, the positional deviation of wafer W (the shot area subject to exposure) within the XY plane due to the change in the distance between movable mirrors 17X, 17Y and wafer W (or to be more specific, the distance between movable mirrors 17X, 17Y and the shot area subject to exposure on wafer W) caused by the deformation of the wafer table (and the wafer) is corrected.

Further, during the scanning exposure described above, wafer stage control system 26 performs auto-focusing and auto-leveling in which wafer table 30 is controlled based on observed values Z, θx, and θy. And on such auto-focusing and auto-leveling, correction value generating section 38 performs feedforward input of correction value (−E_{z}) for thrust in the Z-axis direction to adder 39, and based on a thrust command value, which is thrust command value P_{z} output from control section 36 that has been corrected by the correction value, the Z position of wafer table 30, or more specifically, the distance between projection optical system PL (lens 42) and wafer W in the optical axis direction of projection optical system PL is controlled, which makes it possible to perform auto-focus control of wafer table 30 without any control delay, and allows exposure to be performed in a state where the illumination area on wafer W substantially coincides with the imaging plane of projection optical system PL.

When scanning exposure of the first shot on wafer W is completed in the manner described above, according to instructions from main controller 20, stage controller 19 performs stepping operation of wafer stage WST in the X-axis and Y-axis directions via wafer stage drive section 24, and moves wafer stage WST To the acceleration starting position for exposure of the second shot (the second shot area) on wafer W.

Also during the stepping operation of wafer stage WST in between the exposure of the first shot and the exposure of the second shot, main controller 20 performs the open/close operation or the like of each of the valves performed similar to the one performed when wafer table 30 was moved from the water supply starting position to the acceleration starting position for exposure of the first shot.

Next, scanning exposure similar to the first shot previously described is performed on the second shot on wafer W under the control of main controller 20. In the case of the embodiment, because the so-called alternate scanning is employed, the scanning direction (moving direction) of reticle stage RST and wafer stage WST is opposite when exposing the second shot. In the scanning exposure of the second shot, the processing by main controller 20 and stage controller 19 is basically the same as is previously described. In this case as well, main controller 20 controls the degree of opening of each of the valves that constitute valve groups 62a and 62b, so that a water flow that moves from the rear side of projection unit PU to the front side is generated in the moving direction of wafer W, in the direction opposite to the exposure of the first shot.

In the manner described above, scanning exposure of the m^{th} (m is a natural number) shot area on measurement wafer W and the stepping operation for exposing the m+1^{th} shot area are repeatedly performed, and the pattern of reticle R is sequentially transferred onto all the shot areas subject to exposure on measurement wafer W.

During the scanning exposure of the shot areas from the second shot onward as well, because correction value generating section 38 of wafer stage control system 26 performs feedforward input of correction values −Eₓ and −E_{y} to adder 39, and wafer table 30 (wafer stage WST) is driven by wafer stage drive section 24 based on the thrust command values, which are thrust command values (Pₓ, P_{y}) output from control section 36 that have been corrected by the correction values, the pattern of reticle R is transferred onto the shot areas subject to exposure with good overlay accuracy in a state where the positional deviation of the shot area subject to exposure on wafer W in the X-axis direction and the Y-axis direction due to the supply of water is corrected. Further, correction value generating section 38 performs feedforward input of correction value −E_{Z} for thrust in the Z-axis direction to adder 39, and based on the thrust command value, which is thrust command value P_{Z} output from control section 36 that has been corrected by the correction value, the Z position of wafer table 30 is controlled, which makes it possible to perform auto-focus control of wafer table 30 without any control delay, and allows exposure to be performed in a state where the illumination area on wafer W substantially coincides with the imaging plane of projection optical system PL.

When scanning exposure of the plurality of shot areas on wafer W is completed in the manner described above, main controller 20 gives instructions to stage controller 19, and moves wafer stage WST to the water drainage position previously described. Next, main controller 20 closes all of the valves in valve group 62b, as well as closes all of the valves in valve group 62a. With this operation, the water flowing under lens 42 is completely recovered by liquid recovery unit 72 after a predetermined period of time.

Then, wafer stage WST moves to the wafer exchange position previously described where wafer exchange is performed, and then wafer alignment and exposure as in the description above is performed on the wafer that has been exchanged.

As is obvious from the description so far, in the embodiment, stage controller 19, or to be more specific, wafer stage control system 26 configures a control unit that corrects the positional deviation occurring due to the liquid (water) supply, or in other words, corrects errors of the position of the wafer or fiducial mark plate on the wafer table indirectly measured by the wafer interferometer.

As is described above, according to projection exposure apparatus 100 in the embodiment, wafer stage control system 26 installed within stage controller 19 corrects the positional deviation occurring to wafer W (or fiducial mark plate FM) held on wafer table 30 that accompanies the deformation of wafer table 30 caused by the liquid (water) supply.

Further, according to exposure apparatus 100 in the embodiment, when the reticle pattern is transferred onto each shot area of wafer W by the scanning exposure method, main controller 20 performs the operation of supplying the water to the space between projection unit PU (projection optical system PL) and wafer W on wafer stage WST and the operation of recovering the water in parallel. That is, exposure (transfer of the reticle pattern onto the wafer) is performed in a state where a predetermined amount of water (this water is constantly exchanged) is constantly filled in the space between lens 42 on the tip of projection optical system PL that makes up projection optical system PL and wafer W on wafer stage WST. As a consequence, the immersion method is applied and the wavelength of illumination light IL at the surface of wafer W can be shortened 1/n times (n is the refractive index of the water, 1.4) the wavelength in the air, which improves the resolution of the projection optical system. Further, because the water supplied is constantly exchanged, in case foreign materials adhere on wafer W, the foreign materials are removed by the flow of the water.

Further, because the depth of focus of projection optical system PL is broadened around n times the depth of focus in the air, it is advantageous because it makes it more difficult for defocus to occur when focus leveling operation of wafer W is performed. And, in the case when the depth of focus has to be secured only around the same level as in the case of the air, the numerical aperture (NA) of projection optical system PL can be increased, which also improves the resolution.

In the embodiment above, the case has been described where stage controller 19 corrects the positional deviation of each of the shots on wafer W due to the water supply by changing the thrust given to wafer table 30. The present invention, however, is not limited to this, and especially when scanning exposure is preformed, the thrust given to reticle stage RST or the thrust given to both wafer table 30 and reticle stage RST may be changed so as to correct the positional deviation of each of the shots on wafer W due to the water supply.

Further, in the embodiment above, the thrust command values given to the wafer stage system were corrected according to the correction values from correction value generating section 38, however, the present invention is not limited to this, and the exposure apparatus can employ an arrangement in which the position errors output from substracter 29 are corrected according to the correction values computed by the correction value generating section. In this case, the correction value generating section computes correction values in the dimension that can be added to or subtracted from the errors of the position.

Further, in the embodiment above, the case has been described where stage controller 19 corrects the positional deviation of wafer W or the like accompanying the deformation of the wafer table caused by the water supply, however, instead of, or in addition to this, stage controller 19 can correct the positional deviation caused by the vibration of the wafer table based on the data obtained in advance by simulation or by experiment.

In the embodiment above, during the scanning exposure, main controller 20 adjusts the degree of opening (including a completely closed state and a completely open state) of each valve constituting valve groups 62a and 62b so that a water flow that moves from the rear side of projection unit PU to the front side is created under lens 42 in the moving direction of wafer table 30, that is, in the moving direction of wafer W, the total amount of the water supplied from supply pipes 52 on the rear side of projection unit PU is greater than the total amount of the water supplied from supply pipes 52 on the front side of projection unit PU by ΔQ, while corresponding to this, in the moving direction of wafer W, the total amount of the water recovered via recovery pipes 58 on the front side of projection unit PU is greater than the total amount of the water recovered via recovery pipes 58 on the rear side of projection unit PU by ΔQ. However, the present invention is not limited to this, and main controller 20 can adjust the degree of opening (including a completely closed state and a completely open state) of each valve constituting valve groups 62a and 62b so that during the scanning exposure in the moving direction of wafer W, the water is supplied only from supply pipes 52 on the rear side of projection unit PU, while in the moving direction of wafer W, the water is recovered only via recovery pipes 58 on the front side of projection unit PU. Further, besides when wafer W is moved for scanning exposure, such as for example, during the stepping operation between the shot areas, each of the valves constituting valve groups 62a and 62b can be maintained in a completely closed state.

In the embodiment above, pure water (water) is used as the liquid, however, as a matter of course, the present invention is not limited to this. As the liquid, a liquid that is chemically stable, having high transmittance to illumination light IL and safe to use, such as a fluorine containing inert liquid may be used. As such as a fluorine-containing inert liquid, for example, Fluorinert (the brand name of 3M United States) can be used. The fluorine-containing inert liquid is also excellent from the point of cooling effect. Further, as the liquid, a liquid which has high transmittance to illumination light IL and a refractive index as high as possible, and furthermore, a liquid which is stable against the projection optical system and the photoresist coated on the surface of the wafer (for example, cederwood oil or the like) can also be used. Further, as the liquid, perfluoropolyether (PFPE) can also be used.

Further, in the embodiment above, the liquid that has been recovered may be reused, and in this case, it is preferable to arrange a filter for removing impurities from the recovered liquid in the liquid recovery unit, the recovery pipes, or the like.

In the embodiment above, the optical element of projection optical system PL closest to the image plane side is lens 42. The optical element, however, is not limited to the lens, and it may be an optical plate (parallel plane plate) used for adjusting the optical properties of projection optical system PL such as aberration (such as spherical aberration, coma, or the like), or it may simply be a cover glass. The surface of the optical element of projection optical system PL closest to the image plane side (lens 42 in the embodiment above) may be smudged by coming into contact with the liquid (water, in the embodiment above) due to scattered particles generated from the resist by the irradiation of illumination light IL or adherence of impurities in the liquid. Therefore, the optical element is to be fixed freely detachable (exchangeable) in the lowest section of barrel 40, and may be exchanged periodically.

In such a case, when the optical element that comes into contact with the liquid is lens 42, the cost for replacement parts is high, and the time required for exchange becomes long, which leads to an increase in the maintenance cost (running cost) as well as a decrease in throughput. Therefore, the optical element that comes into contact with the liquid may be, for example, a parallel plane plate, which is less costly than lens 42.

Further, in the embodiment above, the range of the liquid (water) flow only has to be set so that it covers the entire projection area (the irradiation area of illumination light IL) of the pattern image of the reticle. Therefore, the size may be of any size; however, on controlling the flow speed, the flow amount and the like, it is preferable to keep the range slightly larger than the irradiation area but as small as possible.

Furthermore, in the embodiment above, auxiliary plates 22a to 22d are arranged in the periphery of the area where wafer W is mounted on wafer holder 70, however, in the present invention, there are exposure apparatus that do not necessarily require an auxiliary plate or a flat plate having a similar function on the substrate stage. In this case, however, it is preferable to further provide piping on the with the liquid (water, in the embodiment above) due to scattered particles generated from the resist by the irradiation of illumination light IL or adherence of impurities in the liquid. Therefore, the optical element is to be fixed freely detachable (exchangeable) in the lowest section of barrel 40, and may be exchanged periodically.

In such a case, when the optical element that comes into contact with the liquid is lens 42, the cost for replacement parts is high, and the time required for exchange becomes long, which leads to an increase in the maintenance cost (running cost) as well as a decrease in throughput. Therefore, the optical element that comes into contact with the liquid may be, for example, a parallel plane plate, which is less costly than lens 42.

Further, in the embodiment above, the range of the liquid (water) flow only has to be set so that it covers the entire projection area (the irradiation area of illumination light IL) of the pattern image of the reticle. Therefore, the size may be of any size; however, on controlling the flow speed, the flow amount and the like, it is preferable to keep the range slightly larger than the irradiation area but as small as possible.

Furthermore, in the embodiment above, auxiliary plates 22a to 22d are arranged in the periphery of the area where wafer W is mounted on wafer holder 70, however, in the present invention, there are exposure apparatus that do not necessarily require an auxiliary plate or a flat plate having a similar function on the substrate stage. In this case, however, it is preferable to further provide piping on the substrate stage for recovering the liquid so that the supplied liquid is not spilled from the substrate stage.

In the embodiment above, an ArF excimer laser is used as the light source. The present invention, however, is not limited to this, and an ultraviolet light source such as a KrF excimer laser (wavelength 248 nm) may also be used. In addition, for example, the ultraviolet light is not limited only to the laser beams emitted from each of the light sources referred to above, and a harmonic wave (for example, having a wavelength of 193 nm) may also be used that is obtained by amplifying a single-wavelength laser beam in the infrared or visible range emitted by a DFB semiconductor laser or fiber laser, with a fiber amplifier doped with, for example, erbium (Er) (or both erbium and ytteribium (Yb)), and by converting the wavelength into ultraviolet light using a nonlinear optical crystal.

In addition, projection optical system PL is not limited to a dioptric system, and a catadioptric system may also be used. Furthermore, the projection magnification is not limited to magnification such as ¼ or ⅕, and the magnification may also be 1/10 or the like.

In the embodiment described above, the case has been described where the present invention is applied to a scanning exposure apparatus by the step-and-scan method or the like. It is a matter of course, however, that the present invention is not limited to this. More specifically, the present invention can also be suitably applied to a reduction projection exposure apparatus by the step-and-repeat method. In this case, besides the point that static exposure is performed instead of scanning exposure, the exposure apparatus can basically employ a structure similar to the one described in the embodiment previously described and the same effect can be obtained. Further, the present invention can also be applied to a twin-stage type exposure apparatus that comprises two wafer stages.

In the embodiment above, the case has been described of a projection exposure apparatus in which the positional deviation occurring to the substrate (or substrate table) due to the supply of liquid (water) is corrected. The present invention, however, is not limited to the projection exposure apparatus, and the present invention can be applied as long as the apparatus is a stage unit that has a substrate table which movably holds the substrate whose surface is supplied with the liquid. In this case, the apparatus only has to have a position measuring unit for measuring the positional information of the substrate table and a correction unit for correcting the positional deviation that occurs in at least either the substrate or the substrate table due to the liquid supply. In such a case, the correction unit corrects the positional deviation that occurs in at least either the substrate or the substrate table due to the liquid supply. Accordingly, it become possible to move the substrate and the substrate table based on the measurement results of the position measuring unit, without the liquid supplied to the surface of the substrate having any influence on the apparatus.

The exposure apparatus the embodiment described above can be made by incorporating the illumination optical system made up of a plurality of lenses and projection unit PU into the main body of the exposure apparatus, and furthermore by attaching the liquid supply/drainage unit to projection unit PU. Then, along with the optical adjustment operation, parts such as the reticle stage and the wafer stage made up of multiple mechanical parts are also attached to the main body of the exposure apparatus and the wiring and piping connected. And then, total adjustment (such as electrical adjustment and operation check) is performed, which completes the making of the exposure apparatus. The exposure apparatus is preferably built in a clean room where conditions such as the temperature and the degree of cleanliness are controlled.

In addition, in the embodiment described above, the case has been described where the present invention is applied to exposure apparatus used for manufacturing semiconductor devices. The present invention, however, is not limited to this, and it can be widely applied to an exposure apparatus for manufacturing liquid crystal displays which transfers a liquid crystal display deice pattern onto a square shaped glass plate, and to an exposure apparatus for manufacturing thin-film magnetic heads, imaging devices, micromachines, organic EL, DNA chips, or the like.

In addition, the present invention can also be suitably applied to an exposure apparatus that transfers a circuit pattern onto a glass substrate or a silicon wafer not only when producing microdevices such as semiconductors, but also when producing a reticle or a mask used in exposure apparatus such as an optical exposure apparatus, an EUV exposure apparatus, an X-ray exposure apparatus, or an electron beam exposure apparatus. Normally, in the exposure apparatus that uses DUV (far ultraviolet) light or VUV (vacuum ultraviolet) light, a transmittance type reticle is used, and as the reticle substrate, materials such as silica glass, fluorine-doped silica glass, fluorite, magnesium fluoride, or crystal are used.

Semiconductor devices are manufactured through the following steps: a step where the function/performance design of a device is performed; a step where a reticle based on the design step is manufactured; a step where a wafer is manufactured from materials such as silicon; a step where the pattern of the reticle is transferred onto the wafer by the exposure apparatus previously described in the embodiment above; a device assembly step (including processes such as dicing process, bonding process, and packaging process); inspection step, and the like.

### INDUSTRIAL APPLICABILITY

The projection exposure apparatus of the present invention is suitable for manufacturing semiconductor devices. Further, the stage unit of the present invention is suitable as a sample stage of an optical unit to which the immersion method is applied.

What is claimed is:

1. A lithography apparatus focus calibration method, comprising:
projecting a radiation beam, through a liquid between a projection system of a lithography apparatus and a substrate, which is supplied from outside the lithography apparatus on a movable member, onto a target portion of the substrate, using the projection system;
analyzing a focus error resulting from a disturbance caused by a force in an optical axis direction of the projection system, the force being generated by existence of a liquid between a liquid supply system member and the movable member, at a plurality of positions; and
determining compensation data using the determined focus error to compensate the relative position of the substrate and a plane of best focus of the lithography apparatus.

2. The method according to claim 1, wherein
an immersion area is movable relative to the substrate.

3. The method according to claim 1, wherein
projecting the radiation beam is performed under conditions with the force substantially equivalent to a force that acts on the movable member during exposure of a device pattern on a substrate, and determining the compensation data to compensate the relative position of the substrate and the plane of best focus of the lithography apparatus is performed during exposure of the device pattern on the substrate.

4. A lithography apparatus, comprising:
an optical member that projects a radiation beam, through a liquid which at least partly fills a local space between the optical member and a substrate, which is supplied from outside the lithography apparatus, onto a target portion of the substrate;
a movable member on which a substrate is retained that can be moved so that the relative position of the substrate retained by the movable member and a plane of best focus of the optical member is changed; and
a control device that analyzes a focus error resulting from a disturbance caused by a force in an optical axis direction of the optical member, the force being generated by existence of a liquid between a liquid supply system member and the movable member, at a plurality of positions, and determines compensation data using the determined focus error to compensate the relative position of the substrate and the plane of best focus of the optical member.

5. The lithography apparatus according to claim 4, wherein
an immersion area is movable relative to the substrate.

6. The lithography apparatus according to claim 4, wherein
the control device determines the focus error by projecting the radiation beam under conditions with the force substantially equivalent to a force that acts on the movable member during exposure of a device pattern on a substrate, and uses the compensation data to compensate the relative position of the substrate and the plane of best focus of the optical member during exposure of the device pattern on the substrate.

7. The method according to claim 1, wherein
the radiation beam is imparted with a focus test pattern, and
the analyzing the focus error includes analyzing the projected focus test pattern on the substrate.

8. The method according to claim 1, further comprising:
holding, by using a facing member having a facing surface that faces a surface of the substrate, the liquid by the facing member, the projection system and the substrate, while the radiation beam is projected.

9. The lithography apparatus according to claim 4, wherein
the radiation beam is imparted with a focus test pattern, and
the control device analyzes the focus error by analyzing the projected focus test pattern on the substrate.

10. The lithography apparatus according to claim 4, further comprising:
a facing member having a facing surface that faces a surface of the substrate, wherein
the liquid is held by the facing surface, the optical member and the substrate while the radiation beam is projected onto the substrate.

11. A lithography apparatus focus calibration method, comprising:
containing a liquid in a space between a projection system of a lithography apparatus and a movable member of the lithography apparatus using a liquid supply system member, the movable member retaining a substrate supplied from outside the lithography apparatus;
obtaining focus position information of the movable member while the movable member receives a disturbance caused by a force in an optical axis direction of the projection system, the force being generated by existence of a liquid between the liquid supply system member and the movable member, wherein,
the focus position information is obtained by defining a surface of the movable member by a plurality of coordinate values within a plane orthogonal to the optical axis direction and coordinate values in the optical axis direction corresponding to the plurality of coordinate values; and
determining compensation data using the focus position information to compensate the relative position of the substrate and a position of best focus of the lithography apparatus.

12. The method according to claim 11, further comprising:
projecting a radiation beam imparted with a focus test pattern, through a liquid between the projection system of the lithography apparatus and the movable member of the lithography apparatus, onto the substrate; and
analyzing a focus error, wherein
the analyzing the focus error includes analyzing the projected focus test pattern on the substrate.

13. The method according to claim 12, further comprising:
holding, by using a facing member having a facing surface that faces a surface of the substrate, the liquid by the facing member, the projection system and the substrate, while the radiation beam is projected.

14. A lithography apparatus, comprising:
a movable member that is movable retaining a substrate supplied from outside the lithography apparatus;
a liquid supply system member that supplies a liquid in a space between an optical system of the lithography apparatus and the movable member; and
a control device that obtains focus position information of the movable member while the movable member receives a disturbance caused by a force in an optical axis direction of the optical system, the force being generated by existence of a liquid between the liquid supply system member and the movable member, and determines compensation data using the focus position information to compensate the relative position of the substrate and a position of best focus of the optical system, wherein
the focus position information is obtained by defining a surface of the movable member by a plurality of coordinate values within a plane orthogonal to the optical axis direction and coordinate values in the optical axis direction corresponding to the plurality of coordinate values.

15. The lithography apparatus according to claim 14, further comprising:
a projection system which projects a radiation beam imparted with a focus test pattern, through a liquid between the projection system of the lithography apparatus and the movable member of the lithography apparatus, onto the substrate, wherein
the control device analyzes a focus error by analyzing the projected focus test pattern on the substrate.

16. The lithography apparatus according to claim 15, further comprising:
a facing member having a facing surface that faces a surface of the substrate, wherein
the liquid is held by the facing surface, the optical member and the substrate while the radiation beam is projected onto the substrate.
